(19) United States
(12) Patent Application Publication
(10) Pub. No.: US 2026/0332863 A1
(43) Pub. Date: Oct. 22, 2026

(54) METHOD AND APPARATUS FOR GENAI/LLM-ASSISTED SUMMARIZATION OF TV CONTENT TO ENHANCE PAUSE/RESUME FUNCTIONALITY

(71) Applicant: Google LLC, Mountain View, CA (US)

(72) Inventor: Gaurav Arora, Los Gatos, CA (US)

(21) Appl. No.: 19/183,399

(22) Filed: Apr. 18, 2025

(51) Int. Cl. H04N 21/8549; G06F 16/74; H04N 21/2187; H04N 21/431; H04N 21/472

(52) U.S. Cl. CPC H04N 21/8549; G06F 16/74; H04N 21/2187; H04N 21/4312; H04N 21/47217

(57) ABSTRACT

A computing device outputs, for display, a video livestream including content for events occurring in real-time or near real-time. Responsive to receiving a user input that pauses the livestream, the computing device receives the content, and identifies at least a first event by applying a machine learning model to the content. The first event may have a threshold level of importance and may begin at a time between a time at which the livestream was paused and a time at which the livestream is live. The computing device generates a summary of the first event by applying the machine learning model to the content, and outputs, for display, an indication of the summary. Responsive to receiving a user input that selects the indication of the summary of the first event, the computing device adjusts a playback position of the livestream to the time at which the first event begins.

### BACKGROUND

When watching media content, users often have the capability to rewind or fast-forward content to re-watch a scene, re-listen to dialogue, skip scenes, jump to a particular timestamp, etc. When watching live media content, for instance, users may pause the livestream and later fast-forward until they reach the timestamp at which the media content is live. However, adjusting playback is often based on fixed time intervals, which may result in overshooting, and users may skip portions of the media content that they would have otherwise desired to watch. Furthermore, users may prefer to not have to scrub through media to find portions that they have a desire to watch, as this may be time consuming and may worsen user experience. As such, it may be beneficial to highlight portions of media content that is relevant to users.

### SUMMARY

In general, techniques of this disclosure are directed to identifying portions of media content (e.g., a livestream) that are relevant to users while the media is paused. An example computing device (e.g., mobile phone, etc.) may output a video livestream that is transmitted to the computing device in real-time or near real-time, in which the video livestream may include content for a plurality of events occurring in real-time or near real-time. As one example, the video livestream may be a video livestream for a football game, which may include events such as touchdowns, field goals, interceptions, fumbles, etc. The computing device may receive a user input that pauses the livestream. For example, when watching the livestream via a first application installed on the computing device (e.g., an application for a sports broadcasting platform), a user may pause the livestream (e.g., to switch to a second application on the computing device, to attend to other tasks away from the computing device, etc.). Responsive to the computing device receiving the user input that pauses the video livestream, the computing device may receive the content for the plurality of events, and identify at least a first important event from the plurality of events by applying a machine learning module to the content. In some examples, an “important” event may be an event from the plurality of events that has at least a threshold level of importance, which may be based on one or more user preferences. For example, continuing the example above, the computing device may identify a touchdown as an important event. The first event may begin at a time between a time at which the video livestream was paused and a time at which the video livestream is live. The computing device may generate a summary of the first event by applying the machine learning model to the content. For example, the computing device may generate a text summary such as, “Team A scores touchdown.” The computing device may generate, for display, an indication of the summary of the first event (e.g., a graphical component that includes the text summary, in which the graphical component may overlay a user interface for the paused livestream in the first application). Thus, when the user returns to the paused livestream in the first application, the user may select the indication of the summary of the first event, in which the computing device may adjust a playback position of the video livestream to the time at which the first event begins.

In one example, the disclosure is directed toward a method that includes outputting, by a computing device and for display, a video livestream that is transmitted to the computing device in real-time or near real-time, wherein the video livestream includes content for a plurality of events occurring in real-time or near real-time. The method further includes, responsive to receiving a user input that pauses the video livestream, receiving, by the computing device, the content for the plurality of events. The method further includes identifying, by the computing device, at least a first event from the plurality of events by at least applying a machine learning model to the content, wherein the first event from the plurality of events has at least a threshold level of importance, and wherein the first event begins at a time between a time at which the video livestream was paused and a time at which the video livestream is live. The method further includes generating, by the computing device, a summary of the first event by at least applying the machine learning model to the content, and outputting, by the computing device and for display, an indication of the summary of the first event. The method further includes, responsive to receiving a user input that selects the indication of the summary of the first event, adjusting, by the computing device, a playback position of the video livestream to the time at which the first event begins.

In another example, the disclosure is directed toward a computing device that includes one or more processors, and one or more storage devices that store instructions. The instructions, when executed by the one or more processors, cause the one or more processors to output, for display, a video livestream that is transmitted to the computing device in real-time or near real-time, wherein the video livestream includes content for a plurality of events occurring in real-time or near real-time. The instructions further cause the one or more processors to, responsive to receiving a user input that pauses the video livestream, receive the content for the plurality of events. The instructions further cause the one or more processors to identify at least a first event from the plurality of events by at least applying a machine learning model to the content, wherein the first event from the plurality of events has at least a threshold level of importance, and wherein the first event begins at a time between a time at which the video livestream was paused and a time at which the video livestream is live. The instructions further cause the one or more processors to generate a summary of the first event by at least applying the machine learning model to the content, and output, for display, an indication of the summary of the first event. The instructions further cause the one or more processors to, responsive to receiving a user input that selects the indication of the summary of the first event, adjust a playback position of the video livestream to the time at which the first event begins.

In yet another example, the disclosure is directed toward a non-transitory computer-readable storage medium encoded with instructions. The instructions, when executed by one or more processors, cause one or more processors to output, for display, a video livestream that is transmitted to the computing device in real-time or near real-time, wherein the video livestream includes content for a plurality of events occurring in real-time or near real-time. The instructions further cause the one or more processors to, responsive to receiving a user input that pauses the video livestream, receive the content for the plurality of events. The instructions further cause the one or more processors to identify at least a first event from the plurality of events by at least applying a machine learning model to the content, wherein the first event from the plurality of events has at least a threshold level of importance, and wherein the first event begins at a time between a time at which the video livestream was paused and a time at which the video livestream is live. The instructions further cause the one or more processors to generate a summary of the first event by at least applying the machine learning model to the content, and output, for display, an indication of the summary of the first event. The instructions further cause the one or more processors to, responsive to receiving a user input that selects the indication of the summary of the first event, adjust a playback position of the video livestream to the time at which the first event begins.

In yet another example, the disclosure is directed toward a computer program product for identifying important events while a livestream is paused. The computer program product includes instructions that, when executed by one or more processors, cause the one or more processors to output, for display, a video livestream that is transmitted to the computing device in real-time or near real-time, wherein the video livestream includes content for a plurality of events occurring in real-time or near real-time. The instructions further cause the one or more processors to, responsive to receiving a user input that pauses the video livestream, receive the content for the plurality of events. The instructions further cause the one or more processors to identify at least a first event from the plurality of events by at least applying a machine learning model to the content, wherein the first event from the plurality of events has at least a threshold level of importance, and wherein the first event begins at a time between a time at which the video livestream was paused and a time at which the video livestream is live. The instructions further cause the one or more processors to generate a summary of the first event by at least applying the machine learning model to the content, and output, for display, an indication of the summary of the first event. The instructions further cause the one or more processors to, responsive to receiving a user input that selects the indication of the summary of the first event, adjust a playback position of the video livestream to the time at which the first event begins.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example computing device configured to adjust a playback position of a video, in accordance with one or more techniques of this disclosure.

FIG. 2 is a block diagram illustrating an example computing device configured to apply a machine learning model for identifying one or more events included in video content, in accordance with one or more techniques of this disclosure.

FIG. 3A is a conceptual diagram illustrating an example training process for a machine learning module, in accordance with one or more techniques of this disclosure.

FIG. 3B is a conceptual diagram illustrating an example trained machine learning module, in accordance with one or more techniques of this disclosure.

FIG. 3C is a conceptual diagram illustrating an example machine learning module for identifying one or more events included in video content based on user preferences, in accordance with one or more techniques of this disclosure.

FIG. 4 is a conceptual diagram illustrating an example computing device configured to send and receive video content information to and from another computing device via a network, in accordance with one or more techniques of this disclosure.

FIG. 5 is a conceptual diagram illustrating an example computing device for outputting indications of summaries for important events identified in video content, in accordance with one or more techniques of this disclosure.

FIGS. 6A-6B are conceptual diagrams illustrating an example computing device for identifying important events in video content when switching between various applications, in accordance with one or more techniques of this disclosure.

FIG. 7 is a flowchart illustrating an example operation of a computing device for adjusting a playback position of a video based on a selection of one or more identified events, in accordance with one or more techniques of this disclosure.

### DETAILED DESCRIPTION

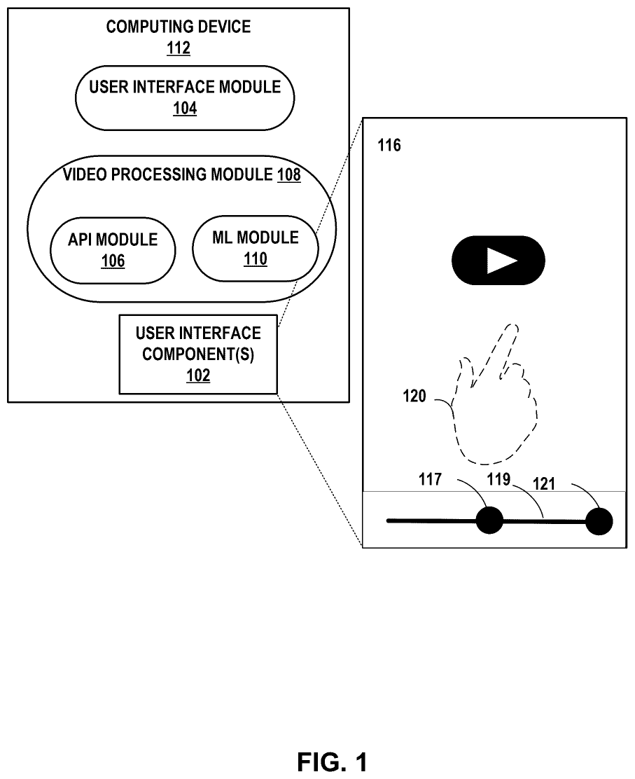

FIG. 1 is a conceptual diagram illustrating an example computing device configured to adjust a playback position of a video, in accordance with one or more techniques of this disclosure. In the example of FIG. 1, a user 120 interacts with computing device 112. While not explicitly shown in the example of FIG. 1, computing device 112 may be, but is not limited to, portable, mobile, or other devices, such as mobile phones (including smartphones), laptop computers, desktop computers, tablet computers, smart television platforms, server computers, mainframes, etc.

As shown in the example of FIG. 1, computing device 112 includes one or more user interface (UI) components (“UI components 102”). UI components 102 of computing device 112 may be configured to function as input devices and/or output devices for computing device 112. UI components 102 may be implemented using various technologies. For instance, UI components 102 may be configured to receive input from user 120 through tactile, audio, and/or video feedback. Examples of input devices include a presence-sensitive display, a presence-sensitive or touch-sensitive input device (such as that shown in FIG. 1), a mouse, a keyboard, a voice responsive system, video camera, microphone, a remote (e.g., a television remote), or any other type of device for detecting a command from user 120. In some examples, a presence-sensitive display includes a touch-sensitive or presence-sensitive input screen, such as a resistive touchscreen, a surface acoustic wave touchscreen, a capacitive touchscreen, a projective capacitance touchscreen, a pressure sensitive screen, an acoustic pulse recognition touch screen, or another presence-sensitive technology. That is, UI components 102 of computing device 112 may include a presence-sensitive device that may receive tactile input from user 120. UI components 102 may receive indications of the tactile input by detecting one or more gestures from user 120 (e.g., when user 120 touches or points to one or more locations of UI components 102 with a finger or a stylus pen).

UI components 102 may additionally or alternatively be configured to function as an output device by providing output to user 120 using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to user 120. Additional examples of an output device include a speaker, a haptic device, or other device that can generate intelligible output to a user. For instance, UI components 102 may present output to user 120 as a graphical user interface (“GUI”) that may be associated with functionality provided by computing device 112. In this way, UI components 102 may present various user interfaces of applications executing at or accessible by computing device 112 (e.g., an electronic message application, an Internet browser application, etc.). User 120 may interact with a respective user interface of an application to cause computing device 112 to perform operations relating to a function provided by the application.

In some examples, UI components 102 of computing device 112 may detect two-dimensional and/or three-dimensional gestures as input from user 120. For instance, a sensor of UI components 102 may detect the user's movement (e.g., moving a hand, an arm, a pen, a stylus, etc.) within a threshold distance of the sensor of UI components 102. UI components 102 may determine a two- or three-dimensional vector representation of the movement and correlate the vector representation to a gesture input (e.g., a hand-wave, a pinch, a clap, a pen stroke, etc.) that has multiple dimensions. In other words, UI components 102 may, in some examples, detect a multidimensional gesture without requiring the user to gesture at or near a screen or surface at which UI components 102 output information for display. Instead, UI components 102 may detect a multi-dimensional gesture performed at or near a sensor which may or may not be located near the screen or surface at which UI components 102 output information for display.

In the example of FIG. 1, computing device 112 includes user interface (UI) module 104. UI module 104 may perform operations described herein using hardware, software, firmware, or a mixture thereof residing in and/or executing at computing device 112. Computing device 112 may execute UI module 104 with one processor or with multiple processors. In some examples, computing device 112 may execute UI module 104 as a virtual machine executing on underlying hardware. UI module 104 may execute as one or more services of an operating system or computing platform or may execute as one or more executable programs at an application layer of a computing platform.

UI module 104, as shown in the example of FIG. 1, may be operable by computing device 112 to perform one or more functions, such as receive input and send indications of such input to other components associated with computing device 112. UI module 104 may also receive data from components associated with computing device 112. Using the data received, UI module 104 may cause other components associated with computing device 112, such as UI components 102, to provide output based on the data. For instance, UI module 104 may send data to UI components 102 of computing device 112 to display a GUI, such as GUI 116.

In the example of FIG. 1, GUI 116 may be a GUI for a first application that can output a video livestream that is transmitted to computing device 112 in real-time or near real-time. For example, in one example, GUI 116 may be a GUI for a sports broadcasting platform, in which GUI 116 may include a livestream for a football game.

A user (e.g., user 120) may interact with GUI 116 to provide an input indicating a request to adjust a playback position of the video livestream. For example, user 120 may interact with UI components 102 to pause the video livestream at time 117. While not explicitly shown in the example of FIG. 1, GUI 116 may include additional or other user interface elements, e.g., buttons that correspond to a video playback feature. For example, computing device 112 may receive an indication of a gesture from user 120 that is detected at a portion of GUI 116 corresponding to a pause function, in which the indication of the gesture is provided by user 120 manually through a tap on the screen. In some examples, the indication of a gesture may be an audible input, in which the gesture is provided by user 120 via, for example, voice command. For example, a user may say the command “pause.” In some examples, as shown in FIG. 1, GUI 116 may include scrub bar 119, which user 120 may interact with to “scrub,” e.g., adjust a playback position for, a video included in GUI 116. In some examples, an indication of a gesture may be provided by user 120 by using gesture control, such as by providing the gestures described above (e.g., a hand-wave, a pinch, a clap, a pen stroke, etc.) or by tapping the screen in a certain manner (e.g., triple tapping the screen). As such, the techniques described herein may be executed by computing device 112 in response to an indication of a variety of gestures that pause a video livestream.

In general, when watching a livestream via a first application installed on the computing device 112 (e.g., an application for a video streaming platform), user 120 may pause the livestream (e.g., to switch to a second application installed on computing device 112, to attend to other tasks away from computing device 112, etc.). When user 120 pauses the video livestream at time 117, though, a plurality of events may occur between time 117 and the time at which the livestream is live (e.g., time 121). For example, in an example in which user 120 pauses a livestream video for a football game, the content may include events such as touchdowns, field goals, interceptions, fumbles, etc. Some of these events may be important to user 120, such that when user 120 returns to the paused livestream in the first application, they may wish to view important events that occurred while the livestream has been paused (e.g., important events that occurred between time 117 and time 121). For example, continuing the example of a football game, user 120 may have a desire to view all touchdowns that occurred while the livestream has been paused. However, user 120 may prefer to not have to use scrub bar 119 to scrub through the entire livestream to find these important events, as this may be time consuming, and may worsen user experience.

As such, responsive to user 120 interacting with GUI 116 to provide an input that pauses the video livestream, video processing module 108 of computing device 112 may retrieve content (e.g., video livestream information such as video transcripts, visual information pertaining to scenes included in the video livestream, audio data, etc.) from the first application via API module 106. In general, video processing module 108 may apply ML module 110, which may be or include one or more machine learning models (e.g., a transformer model, such as a large language model, transcript-matching model, etc.), to the video livestream content. Video processing module 108 may apply ML module 110 to the video livestream content to identify at least a first event from the plurality of events included in the video livestream content. In some examples, video processing module 108 may apply ML module 110 to the video livestream content to generate information indicative of one or more events included in the video livestream content. For example, video processing module 108 may apply ML module 110 to the content for a football game livestream, in which ML module 110 may identify events such as touchdowns, field goals, interceptions, fumbles, etc. In some examples, video processing module 108 may identify one or more “important” events from the plurality of events, in which an important event may be an event that has at least a threshold level of importance. For example, continuing the example above, computing device 112 may identify a touchdown as an important event, but may not identify a timeout as an important event. In some examples, with explicit user consent, the level of importance for an identified event may be based on one or more user preferences and/or historical user data.

In general, user 120 is provided with an opportunity to provide input to control whether programs or features of computing device 112 can collect and make use of user information (e.g., user 120′s personal data, information about user 120's history, etc.), or to dictate whether and/or how computing device 112 may receive content that may be relevant to user 120. Other user information may include data that includes the context of user usage, either obtained from an application itself or from other sources. Examples of usage context may include breadth of share (sharing publicly, or with a large group, or privately, or a specific person), context of share, etc. When permitted by the user, additional data can include the state of the device, e.g., the location of the device, the apps running on the device, etc. In addition, certain data may be treated in one or more ways before it is stored or used by computing device 112 so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, user 120 may have control over how information is collected about them and used by computing device 112. For example, user 120 may be prompted by computing device 112 to provide explicit consent for computing device 112 to retrieve and/or store any or all of user 120's data.

In general, API module 106 of video processing module 108 receives explicit consent from user 120 to gather information from one or more applications installed on and/or executed by computing device 112. In some examples, with explicit consent from user 120, video processing module 108 may run continuously and be configured to monitor the content (e.g., livestream video content) of the active user interface of one or more applications. For example, with explicit consent from user 120, video processing module 108 may run continuously in the background of computing device 112 and be configured to monitor the video content of GUI 116. Video processing module 108 may analyze video livestream information in response to a triggering input (e.g., an input provided mechanically (such as by pressing on GUI 116), by gesture recognition/control (such as triple tapping on a screen by user 120), by audio (such as a verbal command), etc.), or automatically (such that no triggering user input is required), again provided that a user has given explicit permission for video processing module 108 to analyze the video livestream content. In some examples, API module 106 may provide information about user interface elements, events, and actions to assistive technologies (e.g., screen readers, magnification gestures, switch devices, etc.) provided by video processing module 108. In some examples, API module 106 may be configured to enable the exchanging of data in a standardized format. For example, API module 106 may support REST (Representational State Transfer), which is a widely-used architectural style for building APIs that use HTTP (Hypertext Transfer Protocol) to exchange data between applications.

API module 106 may be configured to generate a stream of events as user 120 interacts with computing device 112 and applications executed on computing device 112. In some examples, these events may represent actions and changes in a user interface, such as button presses, text changes, and screen transitions (e.g., user 120 interacting with scrub bar 119 to adjust playback position, user 120 toggling between user interface elements on GUI 116, such as a rewind button, fast-forward button, a pause button, a play button, etc.). With explicit consent from user 120, video processing module 108 may receive and analyze these events to better understand how user 120 interacts with a video livestream playing on computing device 112.

Thus, in the example of FIG. 1, user 120 operating computing device 112 may provide input to one or more of UI components 102, in which the user input pauses a video livestream displayed by GUI 116. With explicit consent from user 120, API module 106 of video processing module 108 may retrieve content included in the video livestream, such as video transcripts, visual information pertaining to scenes included in the video livestream, audio data, etc. In some examples, video processing module 108 may receive at least a portion of the video livestream itself, e.g., the portion of the video livestream that starts at time 117 and ends at time 121, and any data associated with the portion of the video livestream.

In some examples, ML module 110 may receive the video content and generate information indicative of a plurality of events included in the content. For example, ML module 110 may receive a transcript, and then generate an augmented transcript including information indicative of one or more events included in the content. That is, in general, ML module 110 may include one or more machine learning models that have been trained to identify events based on the video livestream content, such as video transcripts, visual information pertaining to scenes included in the video livestream, audio data, etc. In some examples, machine learning module 110 may be trained on a wide variety of data to identify various events, and to further determine levels of importance for identified events. For example, ML module 110 may be trained on a wide variety of audio and/or transcript data such that ML module 110 can identify start times for sentences and/or dialogues. ML module 110 may be trained on a wide variety of visual data such that ML module 110 can identify start times for various scenes. For instance, ML module 110 may be trained on a wide variety of data pertaining to football games, such that ML module 110 can identify a touchdown as a first event and a timeout as a second event, and, in some examples, further identify the touchdown as an important event and the timeout as a non-important event.

In some examples, though, with explicit user consent, machine learning module 110 may determine a level of importance for an identified event based on user preferences. In some examples, machine learning module 110 may determine a level of importance for an identified event based on historical user data that indicates user 120's tendency to view certain events. For example, historical user data may indicate that when user 120 returns to paused livestreams for football games, they typically adjust playback of the livestream to view touchdown events. In some examples, once machine learning module 110 has identified an important event, machine learning module 110 may identify a start time for the identified event. In some examples, with explicit user consent, machine learning module 110 may identify the start time for the identified event based on user preferences and/or historical user data. For example, historical user data may indicate that to view touchdown events, user 120 typically adjusts playback of the livestream to 1 minute before the touchdown is scored.

Thus, in the example of FIG. 1, UI components 102 may output, for display, a video livestream that is transmitted in real-time or near real-time, to computing device 112, in which the video livestream may include content for a plurality of events occurring in real-time or near real-time. Responsive to receiving a user input from user 120 that pauses the video livestream on GUI 116, video processing module 108 may receive the content for the plurality of events, and identify at least a first important event by at least applying machine learning module 110 to the content. That is, video processing module 108 may identify one or more important events that occur between time 117 (e.g., the time at which the video livestream was paused), and time 121 (e.g., the time at which the video livestream is live). Computing device 112 may generate a summary of each identified important event by applying machine learning module 110 to the content, and may output, for display, an indication of each generated summary. For example, an indication of a summary for a first event may be a graphical component overlaid GUI 116, in which the graphical component includes the summary in text. In some examples, as discussed further below, the indication of the summary for the first event may be positioned on a portion of scrub bar 119 that corresponds to a time at which the first event begins. As such, when user 120 returns to GUI 116 including the paused livestream, they may be presented with the one or more indications for the one or more identified important events. Thus, rather than having to use scrub bar 119 to scrub through the entire livestream to find the important events, user 120 may instead select an indication of a summary for an event, and computing device 112 may adjust a playback position of the video livestream to the time at which the event begins.

In this way, the techniques described herein may improve user experience when watching media content, such as live media content. When watching media content, users often have the capability to rewind or fast-forward content to re-watch a scene, re-listen to dialogue, skip scenes, jump to a particular timestamp, etc. However, adjusting playback is often time consuming and/or based on fixed time intervals, which may result in overshooting (e.g., users may skip portions of the media content that they would have otherwise desired to watch) and poor user experience. As such, the techniques described herein may provide a solution for identifying important events in livestreamed media content that occur while the livestreamed media content is paused, and may provide users a more user-friendly method for quickly viewing the important events. Furthermore, the events identified as important may be based on user preferences, and thus the techniques described herein may improve video playback by tailoring it to individual users.

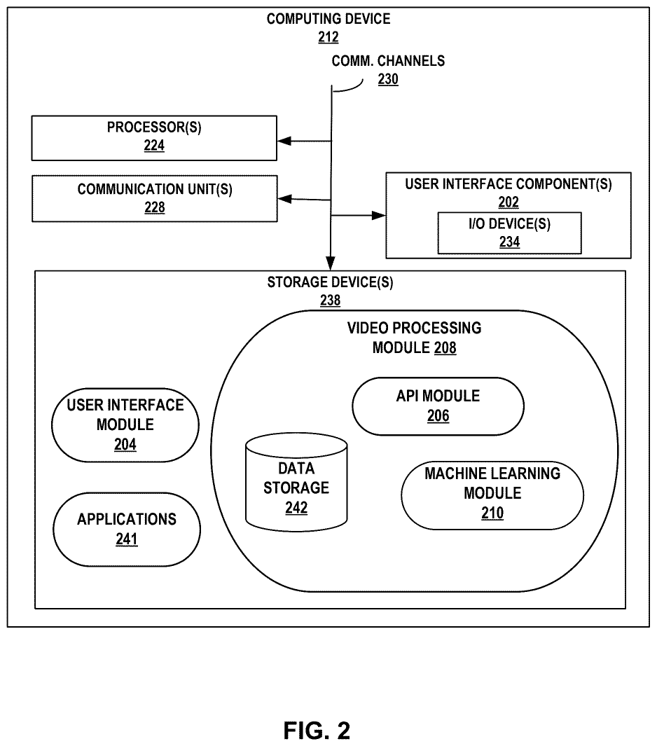

FIG. 2 is a block diagram illustrating an example computing device configured to apply a machine learning model for identifying one or more events included in video content, in accordance with one or more techniques of this disclosure. As shown in the example of FIG. 2, computing device 212 includes processors 224, one or more communication channels 230, one or more user interface components (UIC) 202, one or more communication units 228, and one or more storage devices 238. Storage devices 238 of computing device 212 may include user interface module 204, applications 241, and video processing module 208. As shown in the example of FIG. 2, video processing module 208 further includes API module 206, machine learning module 210, and data storage 242.

Some or all of the components and/or functionality attributed to computing device 212 may be implemented or performed by another computing device and/or computing system in communication with computing device 212. Computing device 212, user interface module 204, video processing module 208, API module 206, machine learning module 210, and user interface (UI) components 202 may be similar if not substantially similar to computing device 112, user interface module 104, video processing module 108, API module 106, machine learning module 110, and user interface (UI) components 102 of FIG. 1, respectively.

The one or more communication units 228 of computing device 212, for example, may communicate with external devices by transmitting and/or receiving data at computing device 212, such as to and from remote computer systems or computing devices. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 230 may interconnect each of the components as shown for inter-component communications (physically, communicatively, and/or operatively). In some examples, communication channels 230 may include a system bus, a network connection (e.g., to a wireless connection), one or more inter-process communication data structures, or any other components for communicating data between hardware and/or software locally or remotely.

One or more I/O devices 234 of computing device 212 may receive inputs and generate outputs. Examples of inputs are tactile, audio, kinetic, and optical input, to name only a few examples. Input devices of I/O devices 234, in one example, may include a touchscreen, a touchpad, a mouse, a keyboard, a voice responsive system, a video camera, buttons, a control pad, a microphone or any other type of device for detecting input from a human or machine. Output devices of I/O devices 234, may include, a sound card, a video graphics adapter card, a speaker, a display, or any other type of device for generating output to a human or machine.

User interface module 204, video processing module 208, API module 206, machine learning module 210, and data storage 242 may perform operations described herein using software, hardware, firmware, or a mixture of hardware, software, and firmware residing in and executing on computing device 212 or at one or more other computing devices (e.g., a cloud-based application-not shown). For example, some or all of modules of FIG. 2 may be included in and executable on another local computing device in communication with computing device 212, e.g., via a local network.

Computing device 212 may execute one or more of the modules included in FIG. 2 with one or more processors 224 or may execute any or part of one or more of the modules included in FIG. 2 as or within a virtual machine executing on underlying hardware. One or more of the modules included in FIG. 2 may be implemented in various ways, for example, as a downloadable or pre-installed application, remotely as a cloud application, or as part of the operating system of computing device 212. Other examples of computing device 212 that implement techniques of this disclosure may include additional components not shown in FIG. 2.

In the example of FIG. 2, one or more processors 224 may implement functionality and/or execute instructions within computing device 212. For example, one or more processors 224 may receive and execute instructions that provide the functionality of UIC 202, communication units 228, one or more storage devices 238 and an operating system to perform one or more operations as described herein. For example, one or more processors 224 may receive and execute instructions that provide the functionality of some or all of the modules included in FIG. 2 to perform one or more operations and various functions described herein. The one or more processors 224 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 238 within computing device 212 may store information, such as information retrieved from a user computing device, or other data discussed herein, for processing during the operation of computing device 212. In some examples, one or more storage devices of storage devices 238 may be a volatile or temporary memory. Examples of volatile memories include random access memories (RAM), dynamic random-access memories (DRAM), static random-access memories (SRAM), and other forms of volatile memories known in the art. Storage devices 238, in some examples, may also include one or more computer-readable storage media. Storage devices 238 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 238 may store program instructions and/or data associated with the modules included in FIG. 2.

In general, with explicit consent from a user, computing device 212 may retrieve, using API module 206, information (e.g., API response data) from one or more applications from applications 241 executing at computing device 212. In general, applications 241 may include different applications (e.g., mobile applications) that are executing at or accessible by computing device 212, including, but not limited to, applications for video streaming platforms, applications for social media platforms, gaming applications, messaging applications, an Internet browser application, etc. etc. Applications 241 may include at least a first application and a second application, in which the first application and the second application may host a variety of content (e.g., media content) that can be displayed to a user of computing device 212. For example, in some examples, the first application and the second application may each output live broadcasts, e.g., video livestreams that are transmitted to computing device 212 in real-time or near real-time. That is, a video livestream may include content for a plurality of events occurring in real-time or near real-time. For instance, the first application may be an application for a sports broadcasting platform that can broadcast a livestream for a football game, and the second application may be an application for a news station that can broadcast a livestream for a severe thunderstorm. In general, UI components 202 may present various user interfaces of applications 241. A user may interact with a respective user interface of an application from applications 241 to cause computing device 212 to perform operations relating to a function provided by the application, such as to view a video livestream that is being broadcasted by the application.

When watching a video livestream via an application, a user may provide input to cause computing device 212 to pause playback of the livestream, and/or may provide one or more other inputs to cause computing device 212 to perform one or more other actions. UI module 204 may interpret these inputs and may relay information about the inputs to one or more associated platforms, operating systems, applications, and/or services executing at the computing device to cause the computing device to perform a function. UI module 204 may also receive information and instructions from one or more associated platforms, operating systems, applications, and/or services executing at the computing device (e.g., video processing module 208) for adjusting a playback position of a video. In addition, UI module 204 may act as an intermediary between the one or more associated platforms, operating systems, applications, and/or services executing at the computing device and various output devices of the computing device (e.g., speakers, LED indicators, vibrators, etc.) to produce output (e.g., graphical, audible, tactile, etc.) with the computing device.

Video processing module 208 may be implemented on a computing device in various ways. For example, video processing module 208 may be implemented as a downloadable or pre-installed application or “app.” In another example, video processing module 208 may be implemented as part of an operating system of a computing device. With explicit consent from the user, responsive to UIC 202 receiving user input that pauses a video livestream in a first application from applications 241, video processing module 208 may retrieve, using API module 206, the content included in the video livestream. That is, video processing module 208 may receive content for a plurality of events occurring in real-time or near real-time while the video livestream is paused in the first application. In some examples, API module 206 may, with user consent, continuously retrieve content included in one or more video livestreams that are being played by one or more applications from applications 241. For instance, while a user is currently watching a video livestream in one application, API module 206 may continuously retrieve content included in a video livestream being played in the background by another application.

Data storage 242 may be a storage repository for a variety of data, e.g., user data (which may only be stored with explicit user consent), input data retrieved from one or more of applications 241 (such as the video livestream content retrieved by API module 206), and/or output data generated by machine learning module 210. In general, data stored in data storage 242 may be accessed by machine learning module 210 for various purposes. For example, a machine learning model employed by ML module 210, such as a model for determining a level of importance for identified events, may be trained on user preference data stored in data storage 242.

In some examples, data storage 242 may operate, at least in part, as a cache for data that is retrieved from applications 241 (e.g., using one or more communication units 228) and/or other computing devices. In general, data storage 242 may be configured as a database, flat file, table, or other data structure stored within storage device 238. In some examples, data storage 242 is shared between various modules executing at computing device 212 (e.g., between one or more modules of FIG. 2 or other modules not shown in FIG. 2). In other examples, a different data repository is configured for a module executing at computing device 212 that requires a data repository. Each data repository may be configured and managed by different modules and may store data in a different manner. In some examples, computing device 212 may receive and store data from a computing device over a specified period of time.

In some examples, the video livestream content retrieved by API module 206 may be preprocessed, which may include extracting one or more additional features from raw data. For example, feature extraction techniques may be applied to the content to generate one or more new, additional features. As an example, in an example in which the content includes video transcript information, video processing module 208 may process the video transcript information to generate augmented video transcript information, which may include additional information indicative of, for example, one or more events included in the content.

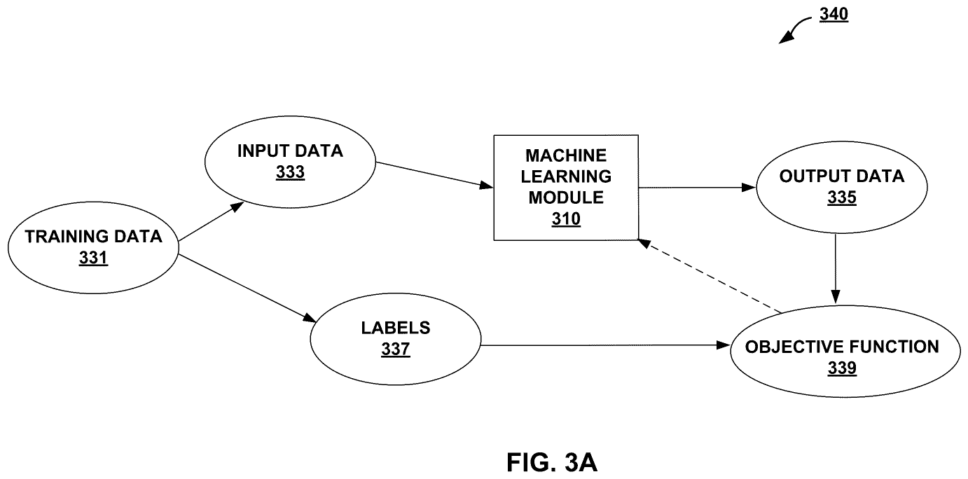

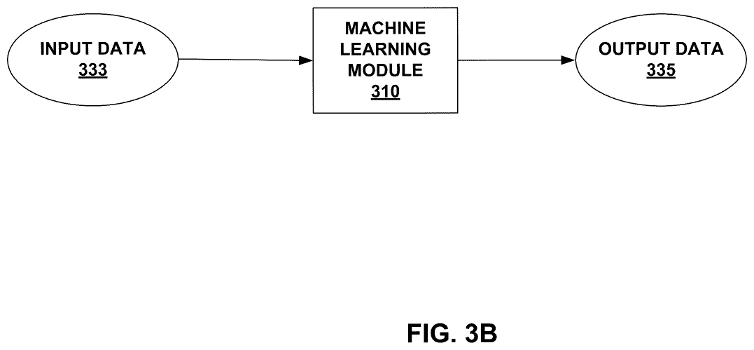

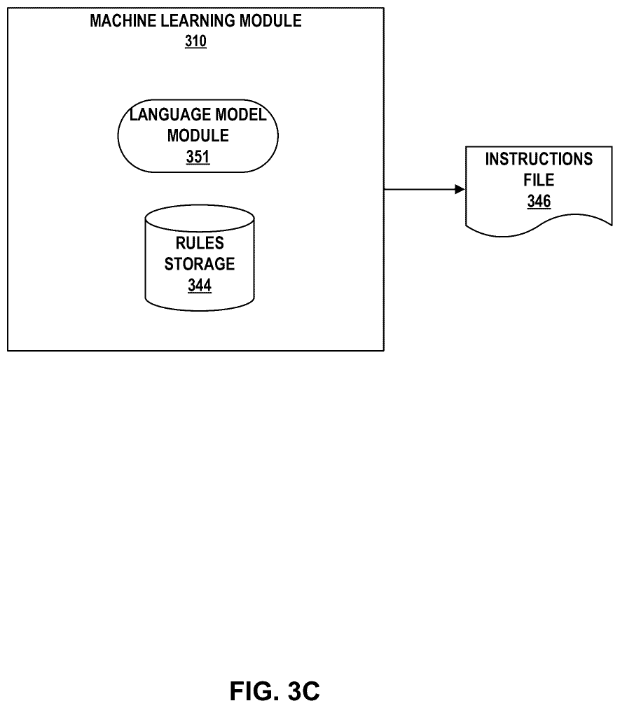

Provided that videos typically include multiple frames associated with timestamps, the content retrieved by API module 206 may be sequential in nature. In some instances, the sequential video information may be generated by sampling or otherwise segmenting a stream of video frames. For example, a segment of video frames may be associated with a particular scene, which may be determined by information included in the video transcript, such as dialogue from a new character, an introduction to a new setting, an alert banner, etc. Thus, in general, using machine learning module 210, video processing module 208 may perform various types of video processing based on user data, user input, retrieved content for video livestreams, etc., which may be referred to collectively as “input data”. Specifically, video processing module 208 may use advanced machine learning techniques, such as those described with respect to FIGS. 3A-3C below, to process the input data and identify events in paused media that may have at least a threshold level of importance to a user. That is, by using one or more of the advanced machine learning techniques described with respect to FIGS. 3A-3C below, video processing module 208 may identify important events in video livestream content, may generate a summary for each identified important event, and may generate, for display, and an indication of each summary (e.g., a graphical component that includes the text summary, in which the graphical component may overlay a user interface for the paused livestream in an application). Thus, when a user returns to the paused livestream in the application, the user may select an indication of a summary of an important event, in which computing device 212 may adjust a playback position of the video livestream to the time at which the important event begins.

FIG. 3A is a conceptual diagram illustrating an example training process for a machine learning module, in accordance with one or more techniques of this disclosure. In some examples, computing device 212 of FIG. 2 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 described herein can be trained at a training computing system, and then provided for storage and/or implementation at one or more computing devices, such as computing device 212 of FIG. 2. In some examples, training process 340 executes locally at computing device 212. However in some examples, training process 340 can be included in or separate from any computing device that implements machine learning module 310.

In general, machine learning module 310 may be or include one or more inference models, i.e., one or more trained machine learning models that can be used to make predictions based on new, unseen data. Machine learning module 310 may “infer” conclusions or outputs, which may be predictions, classifications, recommendations, or other types of decision-making. Machine learning module 310 may be trained according to one or more of various different training types or techniques. For example, in some examples, machine learning module 310 may be trained by training process 340 of FIG. 3A.

As further shown in the example of FIG. 3A, in some examples, machine learning module 310 may be trained on training data 331 that may include input data 333 that has labels 337. The training process shown in FIG. 3A is one example training process; other training processes may be used as well. In general, during training process 340, machine learning module 310 may learn patterns from training data 331, and training process 340 may optimize parameters for machine learning module 310 to minimize prediction errors.

Training data 331 can include, upon user permission for use of such data for training, anonymized usage logs of sharing flows, e.g., content items that were shared together, bundled content pieces already identified as belonging together, e.g., from entities in a knowledge graph, etc. In some examples, training data 331 can include examples of input data 333 that have been assigned labels 337 that correspond to output data 335.

In some examples, machine learning module 310 can be trained by optimizing an objective function, such as objective function 339. For example, in some examples, objective function 339 may be or include a loss function that compares (e.g., determines a difference between) output data generated by the model from the training data and labels (e.g., ground-truth labels) associated with the training data. For example, the loss function can evaluate a sum or mean of squared differences between output data 335 and the labels. In some examples, objective function 339 may be or include a cost function that describes a cost of a certain outcome or output data. Other examples of objective function 339 can include margin-based techniques such as, for example, triplet loss or maximum-margin training.

One or more of various optimization techniques can be performed to optimize objective function 339. For example, the optimization technique(s) can minimize or maximize objective function 339. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some examples, backward propagation of errors can be used in conjunction with an optimization technique (e.g., gradient based techniques) to train machine learning module 310 (e.g., when a machine-learned model is a multi-layer model such as an artificial neural network). For example, an iterative cycle of propagation and model parameter (e.g., weights) update can be performed to train machine learning module 310. Example backpropagation techniques include truncated backpropagation through time, Levenberg-Marquardt backpropagation, etc.

In some examples, machine learning module 310 described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

Machine learning module 310 can be trained using semi-supervised techniques which combine aspects of supervised learning and unsupervised learning. Machine learning module 310 can be trained or otherwise generated through evolutionary techniques or genetic algorithms. In some examples, machine learning module 310 described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected.

In some examples, one or more generalization techniques can be performed during training to improve the generalization of machine learning module 310. Generalization techniques can help reduce overfitting of machine learning module 310 to the training data. Example generalization techniques include dropout techniques; weight decay techniques; batch normalization; early stopping; subset selection; stepwise selection; etc.

In some examples, machine learning module 310 described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some examples, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some examples, transfer learning techniques can be used to provide an initial model from which to begin training of machine learning module 310 described herein. In some examples, transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

In some examples, machine learning module 310 may be trained in an offline fashion or an online fashion. In offline training (also known as batch learning), machine learning module 310 is trained on the entirety of a static set of training data. In online learning, machine learning module 310 is continuously trained (or re-trained) as new training data becomes available (e.g., while the model is used to perform inference).

In some examples, training process 340 may involve centralized training of machine learning module 310 (e.g., based on a centrally stored dataset). In other implementations, decentralized training techniques such as distributed training, federated learning, or the like can be used to train, update, or personalize machine learning module 310.

Machine learning module 310 described herein can be trained according to one or more of various different training types or techniques. For example, in some examples, machine learning module 310 can be trained by training process 340 using supervised learning, in which machine learning module 310 is trained on a training dataset that includes instances or examples that have labels. The labels can be manually applied by experts, generated through crowd-sourcing, or provided by other techniques (e.g., by physics-based or complex mathematical models). In some examples, if the user has provided consent, the training examples can be provided by the user computing device. In some examples, this process can be referred to as personalizing the model.

In some examples, machine learning module 310 includes a language model that may be trained (e.g., pre-trained, fine-tuned, etc.) by training process 340. For example, training process 340 may pre-train a language model on a large and diverse corpus of text. As such, in some examples, training data 331 may include a dataset that covers a wide range of topics and domains to ensure machine learning module 310 learns diverse linguistic patterns and contextual relationships. Training process 340 may train a language model to optimize objective function 339. Objective function 339 may be or include a loss function, such as cross-entropy loss, that compares (e.g., determines a difference between) output data generated by the model from training data 331 and labels 337 (e.g., ground-truth labels) associated with training data 331. For example, objective function 339 for a language model may be to correctly predict the next word in a sequence of words or correctly fill in missing words as much as possible.

In some examples, training process 340 may use techniques such low-rank adaptation (LoRA) to train or fine-tune language models (LLMs) implemented by machine learning module 310. In general, LoRA may reduce the number of trainable parameters by freezing pre-trained weights of an LLM and injecting small, trainable low-rank matrices that adapt the model for specific tasks. LoRa may be useful when a model needs to be adapted to multiple tasks with limited task-specific data. That is, training process 340 may use LoRA for task-specific fine-tuning. In some examples, training process 340 may use techniques such as retrieval-augmented generation (RAG), which is a hybrid framework that combines information retrieval with text generation. RAG may be used to fine-tune a generative model implemented by machine learning module 310 by retrieving relevant information from an external database or dataset (e.g., a large and diverse corpus of text) and using that information to generate output that is more accurate and informative. RAG may be useful for generating more factually accurate and contextually relevant summaries and responses to questions.

In some examples, training process 340 may continuously or periodically train a language model included in machine learning module 310. In some examples, training process 340 may fine-tune a language model by using feedback in the training process. For example, UI components 202 of FIG. 2 may receive a user input via a computing device that selects feedback (e.g., thumbs up, thumbs down, etc.) relating to the generated application functionality and associated GUIs that are presented to the user on the computing device. In some examples, the feedback may indicate whether the generated application functionality and associated GUIs are accurate or inaccurate, correct or incorrect, high quality or low quality, etc. UI module 204 may receive this feedback and may send it to video processing module 208. Video processing module 208 may transmit the feedback to machine learning module 310 (specifically to training process 340), in which training process 340 uses the feedback for training. For example, training process 340 may convert the feedback into labeled data for supervised training. Additionally or alternatively, training process 340 may fine-tune a language model by monitoring the relationship between the performance of the language model and user feedback, and iterate the fine-tuning process as necessary (e.g., to receive more positive user feedback and less negative user feedback). In this way, the techniques of this disclosure may establish a feedback loop that continuously improves the quality of output data 335 (e.g., an instructions file) of a language model.

FIG. 3B is a conceptual diagram illustrating an example trained machine learning module, in accordance with one or more techniques of this disclosure. In some examples, computing device 112 of FIG. 1 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 of FIG. 3B may be trained at a computing system, such as a remote computing system or server, and then provided for storage and/or implementation at one or more computing devices, such as computing device 112 of FIG. 1. In some examples, machine learning module 310 executes locally at computing device 112 of FIG. 1. In some examples, computing device 112 may perform machine learning as a service.

As illustrated in FIG. 3B, in some examples, machine learning module 310 is trained (e.g., via training process 340 of FIG. 3A) to receive input data 333, which may be of one or more types and, in response, provide output data 335, which may be of one or more types. Thus, FIG. 3B illustrates machine learning module 310 performing inference, in which machine learning module 310 may use learned patterns to make predictions or decisions on new data, e.g., input data 333. Machine learning module 310 may include one or more machine-learned models trained by training process 340 of FIG. 3A.

Input data 333 may include one or more features that are associated with an instance or an example. In some examples, the one or more features associated with the instance or example can be organized into a feature vector. In some examples, output data 335 can include one or more predictions. Predictions can also be referred to as inferences. Thus, given features associated with a particular instance, machine learning module 310 can output a prediction for such instance based on the features.

Machine learning module 310 can be or include one or more of various different types of machine-learned models. In particular, in some examples, machine learning module 310 may perform NLP tasks. Machine learning module 310 may summarize, translate, or organize input data 333. Machine learning module 310 may use recurrent neural networks (RNNs) and/or transformer models (self-attention models). Example models may include, but are not limited to, GPT-3, BERT, Gemini (e.g., Gemini Ultra, Gemini Pro, Gemini Flash, Gemini Nano), Android AICore, and T5. In some examples, machine learning module 310 may perform classification, summarization, name generation, regression, clustering, anomaly detection, recommendation generation, and/or other tasks.

In some examples, machine learning module 310 can perform various types of classification based on input data 333. For example, machine learning module 310 can perform binary classification or multiclass classification. In binary classification, output data 335 can include a classification of input data 333 into one of two different classes. In multiclass classification, output data 335 can include a classification of input data 333 into one (or more) of more than two classes. The classifications can be single label or multi-label. Machine learning module 310 may perform discrete categorical classification in which input data 333 is simply classified into one or more classes or categories.

In some examples, machine learning module 310 can perform classification in which machine learning module 310 provides, for each of one or more classes, a numerical value descriptive of a degree to which it is believed that input data 333 should be classified into the corresponding class. In some instances, the numerical values provided by machine learning module 310 can be referred to as “confidence scores” that are indicative of a respective confidence associated with classification of the input into the respective class. In some examples, the confidence scores can be compared to one or more thresholds to render a discrete categorical prediction. In some examples, only a certain number of classes (e.g., one) with the relatively largest confidence scores can be selected to render a discrete categorical prediction.

Machine learning module 310 may output a probabilistic classification. For example, machine learning module 310 may predict, given a sample input, a probability distribution over a set of classes. Thus, rather than outputting only the most likely class to which the sample input should belong, machine learning module 310 can output, for each class, a probability that the sample input belongs to such class. In some examples, the probability distribution over all possible classes can sum to one. In some examples, a Softmax function, or other type of function or layer can be used to squash a set of real values respectively associated with the possible classes to a set of real values in the range (0, 1) that sum to one.

In some examples, the probabilities provided by the probability distribution can be compared to one or more thresholds to render a discrete categorical prediction. In some examples, only a certain number of classes (e.g., one) with the relatively largest predicted probability can be selected to render a discrete categorical prediction.

In cases in which machine learning module 310 performs classification, machine learning module 310 may be trained using supervised learning techniques. For example, machine learning module 310 may be trained on a training dataset that includes training examples labeled as belonging (or not belonging) to one or more classes.

In some examples, machine learning module 310 can perform regression to provide output data in the form of a continuous numeric value. The continuous numeric value can correspond to any number of different metrics or numeric representations, including, for example, currency values, scores, or other numeric representations. As examples, machine learning module 310 can perform linear regression, polynomial regression, or nonlinear regression. As examples, machine learning module 310 can perform simple regression or multiple regression. As described above, in some examples, a Softmax function or other function or layer can be used to squash a set of real values respectively associated with two or more possible classes to a set of real values in the range (0, 1) that sum to one.

Machine learning module 310 may perform various types of clustering. For example, machine learning module 310 can identify one or more previously-defined clusters to which input data 333 most likely corresponds. Machine learning module 310 may identify one or more clusters within input data 333. That is, in instances in which input data 333 includes multiple objects, documents, or other entities, machine learning module 310 can sort the multiple entities included in input data 333 into a number of clusters. In some examples in which machine learning module 310 performs clustering, machine learning module 310 can be trained using unsupervised learning techniques.

Machine learning module 310 may perform anomaly detection or outlier detection. For example, machine learning module 310 can identify input data that does not conform to an expected pattern or other characteristic (e.g., as previously observed from previous input data). As examples, the anomaly detection can be used for fraud detection or system failure detection.

In some examples, machine learning module 310 can provide output data in the form of one or more recommendations. For example, machine learning module 310 can be included in a recommendation system or engine. As an example, given input data that describes previous outcomes for certain entities (e.g., a score, ranking, or rating indicative of an amount of success or enjoyment), machine learning module 310 can output a suggestion or recommendation of one or more additional entities that, based on the previous outcomes, are expected to have a desired outcome (e.g., elicit a score, ranking, or rating indicative of success or enjoyment). As one example, given input data descriptive of a context of a computing device, such as computing device 112 of FIG. 1, a recommendation system can output a suggestion or recommendation of an application that the user might enjoy or wish to download to computing device 112.

Machine learning module 310 may, in some cases, act as an agent within an environment. For example, machine learning module 310 can be trained using reinforcement learning, which will be discussed in further detail below.

In some examples, machine learning module 310 can be a parametric model while, in other implementations, machine learning module 310 can be a non-parametric model. In some examples, machine learning module 310 can be a linear model while, in other implementations, machine learning module 310 can be a non-linear model.

As described above, machine learning module 310 can be or include one or more of various different types of machine-learned models. Examples of such different types of machine-learned models are provided below for illustration. One or more of the example models described below can be used (e.g., combined) to provide output data 335 in response to input data 333. Additional models beyond the example models provided below can be used as well.

In some examples, machine learning module 310 can be or include one or more classifier models such as, for example, linear classification models; quadratic classification models; etc. Machine learning module 310 may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning module 310 can be or include one or more decision tree-based models such as, for example, classification and/or regression trees; iterative dichotomiser 3 decision trees; C4.5 decision trees; chi-squared automatic interaction detection decision trees; decision stumps; conditional decision trees; etc.

Machine learning module 310 may be or include one or more kernel machines. In some examples, machine learning module 310 can be or include one or more support vector machines. Machine learning module 310 may be or include one or more instance-based learning models such as, for example, learning vector quantization models; self-organizing map models; locally weighted learning models; etc. In some examples, machine learning module 310 can be or include one or more nearest neighbor models such as, for example, k-nearest neighbor classifications models; k-nearest neighbors regression models; etc. Machine learning module 310 can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

Machine learning module 310 may be or include one or more sequence processing models, e.g., models configured to ingest, generate, or otherwise reason over sequences of information. Example sequence processing models include, but are not limited to, sequence processing models that can process text data (e.g., large language models, PaLM 2 Technical Report, Google, https://ai.google/static/documents/palm2techreport.pdf (n.d.)), sequence processing models that can process image data (e.g., Dosovitskiy et al., An Image is Worth 16×16 Words: Transformers for Image Recognition at Scale, arXiv:2010.11929v2 (Jun. 3, 2021)), sequence processing models that can process audio data (e.g., Agostinelli et al., MusicLM: Generating Music From Text, arXiv:2301.11325v1 (Jan. 26, 2023)), sequence processing models that can process biochemical data (e.g., Jumper et al., Highly accurate protein structure prediction with AlphaFold, 596 Nature 583 (Aug. 26, 2021)), etc. In general, a sequence processing model can process one or more types of data simultaneously. A sequence processing model can include relatively large models (e.g., models that process a large number of parameters, models that are computationally expensive, etc.), relatively small models (e.g., models that process a fewer number of parameters, models that are computationally lightweight, etc.), or both.

In some examples, machine learning module 310 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

Machine learning module 310 can be or include one or more feed forward neural networks. In feed forward networks, the connections between nodes do not form a cycle. For example, each connection can connect a node from an earlier layer to a node from a later layer.

In some instances, machine learning module 310 can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of input data 333 sequence to a subsequent portion of input data 333 sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, machine learning module 310 can be or include one or more convolutional neural networks. In some instances, a convolutional neural network can include one or more convolutional layers that perform convolutions over input data using learned filters.

Filters can also be referred to as kernels. Convolutional neural networks can be especially useful for vision problems such as when input data 333 includes imagery such as still images or video. However, convolutional neural networks can also be applied for natural language processing.

In some examples, machine learning module 310 can be or include one or more generative networks such as, for example, generative adversarial networks. Generative networks can be used to generate new data such as new images or other content.

Machine learning module 310 may be or include an autoencoder. In some instances, the aim of an autoencoder is to learn a representation (e.g., a lower-dimensional encoding) for a set of data, typically for the purpose of dimensionality reduction. For example, in some instances, an autoencoder can seek to encode input data 333 and then provide output data that reconstructs input data 333 from the encoding. Recently, the autoencoder concept has become more widely used for learning generative models of data. In some instances, the autoencoder can include additional losses beyond reconstructing input data 333.

Machine learning module 310 may be or include one or more other forms of artificial neural networks such as, for example, deep Boltzmann machines; deep belief networks; stacked autoencoders; etc. Any of the neural networks described herein can be combined (e.g., stacked) to form more complex networks.

One or more neural networks can be used to provide an embedding based on input data 333. For example, the embedding can be a representation of knowledge abstracted from input data 333 into one or more learned dimensions. In some instances, embeddings can be a useful source for identifying related entities. In some instances, embeddings can be extracted from the output of the network, while in other instances embeddings can be extracted from any hidden node or layer of the network (e.g., a close to final but not final layer of the network). Embeddings can be useful for performing auto suggest next video, product suggestion, entity or object recognition, etc. In some instances, embeddings can be useful inputs for downstream models. For example, embeddings can be useful to generalize input data (e.g., search queries) for a downstream model or processing system.

Machine learning module 310 may include one or more clustering models such as, for example, k-means clustering models; k-medians clustering models; expectation maximization models; hierarchical clustering models; etc.

In some examples, machine learning module 310 can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, machine learning module 310 can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some examples, machine learning module 310 can be an autoregressive model. In some instances, an autoregressive model can specify that output data 335 depends linearly on its own previous values and on a stochastic term. In some instances, an autoregressive model can take the form of a stochastic difference equation. One example autoregressive model is WaveNet, which is a generative model for raw audio.

In some examples, machine learning module 310 can include or form part of a multiple model ensemble. As one example, bootstrap aggregating can be performed, which can also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models can be combined (e.g., through averaging, voting, or other techniques) and used as the output of the ensemble.

One example ensemble is a random forest, which can also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees can be used as the output of the forest. Random decision forests can correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of same or different type) can be trained based on training data. In addition, a combiner model can be trained to take the predictions from the other machine-learned models as inputs and, in response, produce a final inference or prediction. In some instances, a single-layer logistic regression model can be used as the combiner model.

Another example of an ensemble technique is boosting. Boosting can include incrementally building an ensemble by iteratively training weak models and then adding to a final strong model. For example, in some instances, each new model can be trained to emphasize the training examples that previous models misinterpreted (e.g., misclassified). For example, a weight associated with each of such misinterpreted examples can be increased. One common implementation of boosting is AdaBoost, which can also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) can be combined to form an ensemble. As an example, an ensemble can include a top level machine-learned model or a heuristic function to combine and/or weight the outputs of the models that form the ensemble.

In some examples, multiple machine-learned models (e.g., that form an ensemble can be linked and trained jointly (e.g., through backpropagation of errors sequentially through the model ensemble). However, in some examples, only a subset (e.g., one) of the jointly trained models is used for inference.

In some examples, machine learning module 310 can be used to preprocess input data 333 for subsequent input into another model. For example, machine learning module 310 can perform dimensionality reduction techniques and embeddings (e.g., matrix factorization, principal components analysis, singular value decomposition, word2vec/GLOVE, and/or related approaches); clustering; and even classification and regression for downstream consumption.

As discussed above, machine learning module 310 can be trained or otherwise configured to receive input data 333 and, in response, provide output data 335. Input data 333 can include different types, forms, or variations of input data. As examples, in various implementations, input data 333 can include features that describe the content (or portion of content) initially selected by the user, e.g., content of user-selected document or image, links pointing to the user selection, links within the user selection relating to other files available on device or cloud, metadata of user selection, etc. Additionally, with user permission, input data 333 includes the context of user usage, either obtained from the app itself or from other sources. Examples of usage context include breadth of share (sharing publicly, or with a large group, or privately, or a specific person), context of share, etc. When permitted by the user, additional input data can include the state of the device, e.g., the location of the device, the apps running on the device, etc.

In some examples, machine learning module 310 can receive and use input data 333 in its raw form. In some examples, the raw input data can be preprocessed. Thus, in addition or alternatively to the raw input data, machine learning module 310 can receive and use the preprocessed input data.

In some examples, preprocessing input data 333 can include extracting one or more additional features from the raw input data. For example, feature extraction techniques can be applied to input data 333 to generate one or more new, additional features. Example feature extraction techniques include edge detection; corner detection; blob detection; ridge detection; scale-invariant feature transform; motion detection; optical flow; Hough transform; etc.

In some examples, the extracted features can include or be derived from transformations of input data 333 into other domains and/or dimensions. As an example, the extracted features can include or be derived from transformations of input data 333 into the frequency domain. For example, wavelet transformations and/or fast Fourier transforms can be performed on input data 333 to generate additional features.

In some examples, the extracted features can include statistics calculated from input data 333 or certain portions or dimensions of input data 333. Example statistics include the mode, mean, maximum, minimum, or other metrics of input data 333 or portions thereof.

In some examples, as described above, input data 333 can be sequential in nature. In some instances, the sequential input data can be generated by sampling or otherwise segmenting a stream of input data. As one example, frames can be extracted from a video. In some examples, sequential data can be made non-sequential through summarization.

As another example preprocessing technique, portions of input data 333 can be imputed. For example, additional synthetic input data can be generated through interpolation and/or extrapolation.

As another example preprocessing technique, some or all of input data 333 can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of input data 333 can be normalized by subtracting the mean across a given dimension's feature values from each individual feature value and then dividing by the standard deviation or other metric.

As another example preprocessing technique, some or all or input data 333 can be quantized or discretized. In some cases, qualitative features or variables included in input data 333 can be converted to quantitative features or variables. For example, one hot encoding can be performed.

In some examples, dimensionality reduction techniques can be applied to input data 333 prior to input into machine learning module 310. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, during training, input data 333 can be intentionally deformed in any number of ways to increase model robustness, generalization, or other qualities. Example techniques to deform input data 333 include adding noise; changing color, shade, or hue; magnification; segmentation; amplification; etc.

In response to receipt of input data 333, machine learning module 310 can provide output data 335. Output data 335 can include different types, forms, or variations of output data. As examples, in various implementations, output data 335 can include content, either stored locally on the user device or in the cloud, that is relevantly shareable along with the initial content selection.

As discussed above, in some examples, output data 335 can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.). In other instances, output data 335 can include clustering data, anomaly detection data, recommendation data, or any of the other forms of output data discussed above.

In some examples, output data 335 can influence downstream processes or decision making. As one example, in some examples, output data 335 can be interpreted and/or acted upon by a rules-based regulator.

Any of the different types or forms of input data described herein can be combined with any of the different types or forms of machine-learned models described herein to provide any of the different types or forms of output data described herein.

The systems and methods of the present disclosure can be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof. A computing system that implements machine learning module 310 or other aspects of the present disclosure may include a number of hardware components that enable the performance of the techniques described herein.

In some instances, output data 335 obtained through machine learning module 310 at a computing system or device can be used to improve other device tasks or can be used by other non-user devices to improve services performed by or for such other non-user devices. For example, output data 335 can improve other downstream processes performed by a server device for a computing device of a user or embedded computing device. In other instances, output data 335 obtained through implementation of machine learning module 310 at a computing system or device can be sent to and used by a user computing device, an embedded computing device, or some other client device. In some examples, computing device 212 of FIG. 2 may perform machine learning as a service.

In yet other implementations, different respective portions of machine learning module 310 can be stored at and/or implemented by some combination of a user computing device; an embedded computing device; a server computing device; etc. In other words, portions of machine learning module 310 may be distributed in whole or in part amongst a client device (e.g., computing device 112 of FIG. 1) and a remote computing system or server.

A computing device such as computing device 112 of FIG. 1 may perform graph processing techniques or other machine learning techniques using one or more machine learning platforms, frameworks, and/or libraries, such as, for example, TensorFlow, Caffe/Caffe2, Theano, Torch/PyTorch, MXnet, CNTK, etc.

In some examples, multiple instances of machine learning module 310 can be parallelized to provide increased processing throughput. For example, the multiple instances of machine learning module 310 can be parallelized on a single processing device or computing device or parallelized across multiple processing devices or computing devices.

A computing device that implements machine learning module 310 or other aspects of the present disclosure can include a number of hardware components that enable performance of the techniques described herein. For example, a computing device can include one or more memory devices that store some or all of machine learning module 310. For example, machine learning module 310 can be a structured numerical representation that is stored in memory. The one or more memory devices can also include instructions for implementing machine learning module 310 or performing other operations. Example memory devices include RAM, ROM, EEPROM, EPROM, flash memory devices, magnetic disks, etc., and combinations thereof.

A computing device can also include one or more processing devices that implement some or all of machine learning module 310 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or other processing device; an application specific integrated circuit (ASIC); a field programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed computing devices and/or virtually distributed computing systems.

In some examples, machine learning module 310 described herein can be included in different portions of computer-readable code on a computing device. In one example, machine learning module 310 can be included in a particular application or program and used (e.g., exclusively) by such a particular application or program. Thus, in one example, a computing device can include a number of applications and one or more of such applications can contain its own respective machine learning library and machine-learned model(s).

In another example, machine learning module 310 described herein can be included in an operating system of a computing device (e.g., in a central intelligence layer of an operating system) and can be called or otherwise used by one or more applications that interact with the operating system. In some examples, each application can communicate with the central intelligence layer (and model(s) stored therein) using an application programming interface (API) (e.g., a common, public API across all applications).

In some examples, the central intelligence layer can communicate with a central device data layer. The central device data layer can be a centralized repository of data for the computing device. The central device data layer can communicate with a number of other components of the computing device, such as, for example, one or more sensors, a context manager, a device state component, and/or additional components. In some examples, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination.

Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Further to the descriptions above, a user may be provided with controls that enable the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 3C is a conceptual diagram illustrating an example machine learning module for identifying one or more events included in video content based on user preferences, in accordance with one or more techniques of this disclosure.

Machine learning module 310 of FIG. 3C may be an example of machine learning module 310 of FIGS. 3A and 3B. In general, ML module 310 may be or include one or more machine learning models that can identify a plurality of events included in video content (e.g., livestream video content). In some examples, a single model (e.g., a single model trained end-to-end) may perform one or more of the machine learning techniques described herein. In some examples, machine learning module 310 may perform speech recognition, e.g., may convert spoken words or dialogue in an audio recording to text. In some examples, machine learning module 310 may process audio files to extract features such as phonemes and other acoustic signals. In some examples, machine learning module 310 may employ one or more alignment algorithms that may better align generated text data with audio data, such as Dynamic Time Warping (DTW) or Hidden Markov Models (HMMs). In this way, machine learning module 310 may synchronize subtitles or captions with dialogue in a video, such as to accurately time spoken words in audio data. In some examples, machine learning module 310 may employ timestamping, in which time markers may be added to video content information to indicate the start time for an event in an audio or video.

ML module 310 may be or include one or more transformer-based neural networks, such as language model module 351, which may be or include a large language model (LLM) and/or other models capable of performing natural language processing (NLP) tasks. Language model module 351 may implement, for example, the Pathways Language Model developed by Google. Transformer-based neural networks may refer to a type of deep learning architecture specifically designed for handling sequential data, such as text or time series. In other words, transformer-based neural networks like LLMs may be configured to perform natural language processing (NLP) tasks, such as question-answering, machine translation, text summarization, and sentiment analysis. Language model module 351 may be configured to perform tasks such as classification, sentiment analysis, entity extraction, extractive question answering, summarization, re-writing text in a different style, ad copy generation, and concept ideation.

Transformer-based neural networks may utilize a self-attention mechanism, which allows the model to weigh the importance of different elements in a given input sequence relative to each other. The self-attention mechanism may help language model module 351 effectively capture long-range dependencies and complex relationships between elements, such as words in a sentence.

Language model module 351 may include an encoder and a decoder that operate to process and generate sequential data, such as structured text. Both the encoder and decoder may include one or more of self-attention mechanisms, position-wise feedforward networks, layer normalization, or residual connections. In some examples, the encoder may process an input sequence and create a representation that captures the relationships and context among the elements in the sequence. The decoder may then obtain the representation generated by the encoder and produce an output sequence. In some examples, the decoder may generate the output one element at a time (e.g., one word at a time), using a process called autoregressive decoding, where the previously generated elements are used as input to predict the next element in the sequence.

In some examples, language model module 351 may determine a set of information types included in the livestream video content. An information type may be or otherwise include a topic, theme, point, subject, purpose, intent, keyword, etc. In some examples, language model module 351 may determine the information type by leveraging a self-attention mechanism to capture the relationships and dependencies between words in the input sequence. For example, language model module 351 may tokenize (e.g., split) a sequence of words or subwords, which language model module 351 may convert into vectors (e.g., numerical representations) that language model module 351 can process. Language model module 351 may use the self-attention mechanism to weigh the importance of each token in relation to the others. In this way, language model module 351 may identify patterns and relationships between the tokens, and in turn the words corresponding to the tokens, that indicate one or more information types of the accessibility information.

In general, language model module 351 may excel at performing NLP tasks, such as generating text and other content (e.g., summaries of identified events). However, with respect to specific types of content (e.g., specific information types), language model module 351 may have an increased likelihood of generating false, inaccurate, or bad quality information. To address this issue, language model module 351 may be configured to adhere to one or more rules when generating output. Thus, input information may be passed in language model module 351 with certain prerequisites, prompts, or “rules” that can be stored in rules storage 344. Machine learning module 310 may apply these prerequisites, prompts, or rules when generating summaries for identified events, and/or when generating instructions file 346 including instructions for generating indications (e.g., graphical components) of the summaries.

For example, rules storage 344 may implement a rule such as, “Do not include a text summary that includes more than 50 characters” when generating instructions file 346 for generating an indication of a summary of an event. In some examples, machine learning module 310 may use accessibility information when generating instructions file 346, such that the user can easily interact with the indications of the summaries. In some examples, the rules may be text inputs such as, for example, “The background color of the graphical component that includes the summary should be associated with the event.” As such, rules storage 344 may store a plurality of text inputs and/or other data that further specify how instructions file 346 should be generated by machine learning module 310. Other example information stored in rules storage 344 may pertain to output format, user interface layouts, allowed data types, a UI component library that can be used to build end result UI, an API library including APIs that can be used to retrieve data from applications, user permissions, etc. Because language model module 351 can interpret the rules along with the input (e.g., the livestream video content), the computing device may provide more accurate instructions for generating indications of summaries of identified important events.

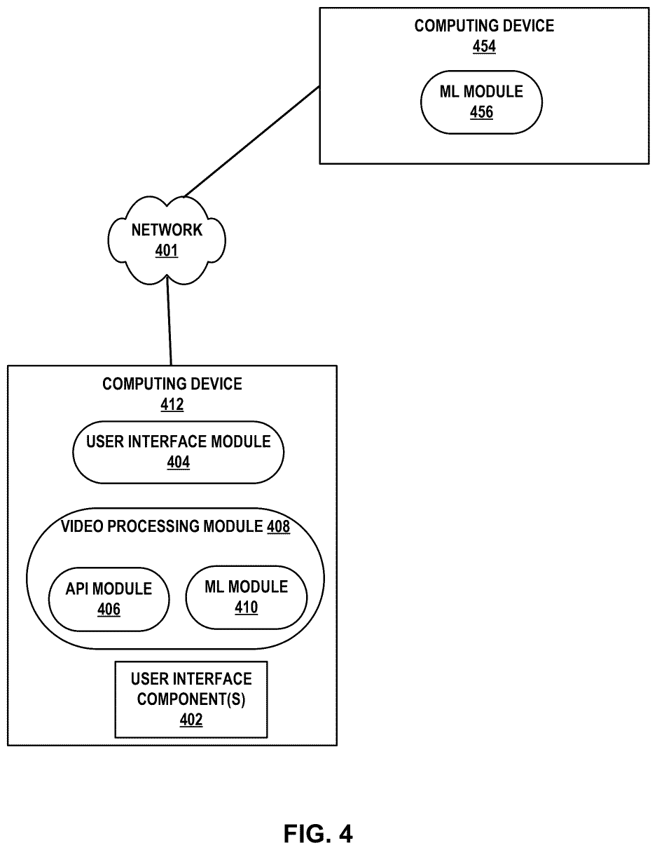

FIG. 4 is a conceptual diagram illustrating an example computing device configured to send and receive video content information to and from another computing device via a network, in accordance with one or more techniques of this disclosure. Computing device 412, user interface module 404, video processing module 408, API module 406, ML module 410, and user interface components 402 may be similar if not substantially similar to computing device 212, user interface module 204, video processing module 208, API module 206, ML module 210, and user interface components 202 of FIG. 2, respectively. In some examples, computing device 412 may be a first local computing device in communication with one or more other computing devices via network 401, which may be a local network. For example, in the example of FIG. 4, computing device 412 may be in communication with computing device 454 via network 401. In general, computing device 454 may be a local computing device. While not explicitly shown in the example of FIG. 4, computing device 454 may be, but is not limited to, portable, mobile, or other devices, such as mobile phones (including smartphones), laptop computers, desktop computers, tablet computers, smart television platforms, server computers, mainframes, etc. In some examples, computing device 454 may represent a cloud computing system that provides one or more services via network 401. That is, in some examples, computing device 454 may be a distributed computing system.

In some examples, computing device 412 may not have the computing resources necessary for performing advanced machine learning techniques. As such, in some examples, to apply machine learning module 410 to the video livestream content retrieved by API module 406, computing device 412 may send, via local network 401, the content to computing device 454, in which computing device 454 includes machine learning module 456. In general, machine learning module 456 may be or include one or more machine learning models, such as those described with respect to FIGS. 3A-3C. That is, in some examples, computing device 412 may “offload” more computationally expensive machine learning tasks to computing device 454, in which machine learning module 456 may perform one or more of the machine learning techniques described herein. That is, FIG. 4 may illustrate a networked device implementation in which processing is offloaded to computing device 454, which may be a more capable device on network 401 (which may be a LAN). For example, machine learning module 456 may include one or more transformer models (e.g., a large language model) that can receive the video livestream content as input and generate information indicative of the summary for one or more events as output. As such, in the example of FIG. 4, computing device 412 may receive, from computing device 454 via local network 401, information indicative of summaries for one or more events.

As an example, in one example, computing device 412 may be a television (e.g., a smart television), computing device 454 may be a user device (e.g., a mobile phone, tablet, or laptop), and computing device 412 and computing device 454 may be in communication via a Wi-Fi network. In some examples, although not shown in FIG. 4, an intermediary device may additionally or alternatively be used to connect computing device 412 and computing device 454 and facilitate receiving and streaming of content between the two devices. For example, an intermediary device may connect to an HDMI port included in computing device 412, and may be controlled using computing device 454 (e.g., using an application for communication with the intermediary device that is installed on computing device 454), an input device such as a remote, etc. In some examples, one or more applications installed on computing device 454 may “cast” content (e.g., a livestream) to the intermediary device, in which the intermediary device may download and/or output the content via UI components 402 of computing device 412. While the content (e.g., the livestream) is output for display by computing device 412, a user operating computing device 454 may use other applications installed on computing device 454, may control one or more functions of computing device 412 (e.g., a user may pause the livestream being output by computing device 412 by providing input to computing device 454), etc. In this particular example in which computing device 412 may be a television, computing device 412 may not have the capability to perform the machine learning techniques described herein; as such, computing device 454 may be employed to handle more computationally expensive machine learning tasks.

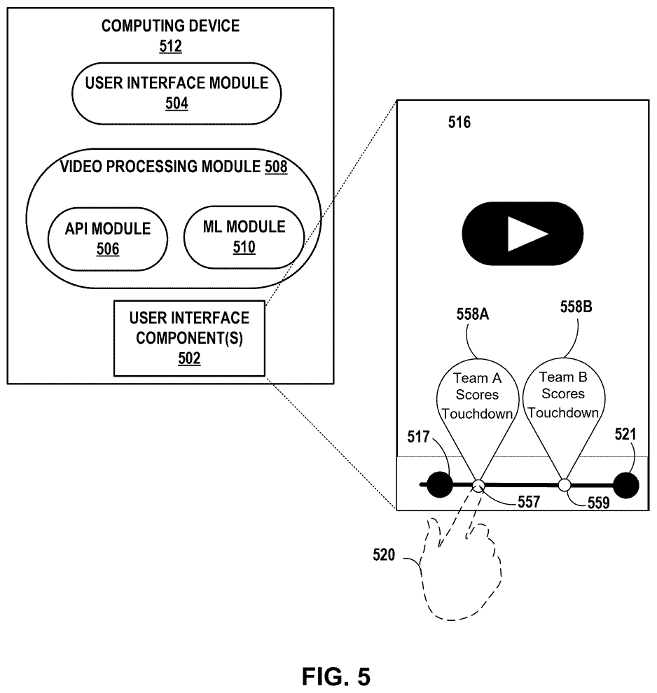

FIG. 5 is a conceptual diagram illustrating an example computing device for outputting indications of summaries for important events identified in video content, in accordance with one or more techniques of this disclosure. In general, computing device 512 may output a video livestream that is transmitted to computing device 512 in real-time or near real-time, in which the video livestream may include content for a plurality of events occurring in real-time or near real-time. In the example of FIG. 5, the video livestream may be a video livestream for a football game, which may include events such as touchdowns, field goals, interceptions, fumbles, etc. Computing device 512 may receive a user input from user 520 that pauses the livestream. For example, when watching the livestream via a first application installed on computing device 512 (e.g., an application for a sports broadcasting platform), user 520 may pause the livestream by interacting with GUI 516. For example, user 520 may pause the livestream of the football game to switch to a second application installed on computing device 512, to attend to other tasks away from computing device 512, etc.

As such, responsive to computing device 512 receiving the user input that pauses the video livestream, API module 506 of video processing module 508 may retrieve the content for the plurality of events. Video processing module 508 may identify at least a first important event from the plurality of events by applying machine learning module 510 to the content. In some examples, an “important” event may be an event from the plurality of events that has at least a threshold level of importance, which may be based on one or more user preferences. In some examples, the one or more user preferences may be determined by computing system 500 based on historical user interaction information that is received by computing system 500 (so long as user 520 has provided explicit consent). As one example, the historical user interaction information may indicate that when user 520 returns to paused livestreams for football games, they frequently adjust playback position of the livestream to view touchdown events. As such, in the example of FIG. 5, for example, machine learning module 510 may identify a touchdown scored by Team A as a first important event. The first event may begin at time 557, which may be a time between time 517 (e.g., the time at which the video livestream was paused) and time 521 (e.g., a time at which the video livestream is live). In some examples, the one or more user preferences may be based on input explicitly provided by user 520. In some examples, the threshold level of importance may be a value, and machine learning module 510 may assign a respective value to each event that is indicative of the importance of the event. That is, in some examples, machine learning module 510 may score each event, and may only determine events with a threshold score to be important. In some examples, the threshold value may be 50%, 60%, 70%, 80%, 90%, etc. In some examples, rather than using a threshold value, machine learning module 510 may determine a certain number of events (e.g., 3 events, 5 events, 7 events, etc.) with the highest scores, and may determine those events to be important.

As shown in the example of FIG. 5, video processing module 508 may generate a summary of the first event by applying machine learning module 510 to the content, and may output, for display, indication 558A of the summary of the first event. For example, video processing module 508 may generate a text summary such as, “Team A scores touchdown.” UI module 504 may generate, for display by UI components 502, indication 558A, which may be a graphical component that includes the text summary “Team A scores touchdown.” As shown, indication 558A may overlay a portion of the scrub bar that corresponds to time 557 at which the Team A touchdown event begins.

As shown in the example of FIG. 5, in some examples, video processing module 508 may identify at least a second event from the plurality of events by at least applying machine learning module 510 to the content, in which the second event from the plurality of events has at least the threshold level of importance. For example, machine learning module 510 may identify a touchdown scored by Team B as a second important event. The second event may begin at time 559 between time 517 (e.g., the time at which the video livestream was paused) and time 521 (e.g., the time at which the video livestream is live). Video processing module 508 may generate a summary of the second event by applying machine learning module 510 to the content, and may output, for display, indication 558B of the summary of the second event. For example, video processing module 508 may generate a text summary such as, “Team B scores touchdown.” UI module 504 may generate, for display by UI components 502, indication 558B, which may be a graphical component that includes the text summary “Team B scores touchdown.” As shown, indication 558B may overlay a portion of the scrub bar that corresponds to time 559 at which the Team B touchdown event begins.

Thus, when user 520 returns to the paused livestream in the first application, i.e., when user 520 returns to GUI 516, user 520 may interact with GUI 516 to select indication 558A to cause computing device 512 to adjust the playback position of the video livestream to time 557, and/or may interact with GUI 516 to select indication 558B to cause computing device 512 to adjust the playback position of the video livestream to time 559.

In some examples, computing device 512 may receive a request to adjust the playback position of the video livestream to time 521 (e.g., the time at which the video livestream is live). In general, video processing module 508 may continuously receive the content for the video livestream until computing device 512 receives the request to adjust the playback position of the video livestream to time 521. That is, for example, when user 520 selects indication 558A to adjust the playback position of the livestream to time 557, video processing module 508 may still receive content for the video livestream as it is transmitted to computing device 512. That is, GUI 516 may be continuously updated to include an indication of each summary that is generated by machine learning module 510, until computing device 512 receives a request to adjust the playback position of the video livestream to time 521.

As such, the techniques described herein may provide solutions for identifying portions of a paused livestream that may be relevant or important to users, and further may allow users to quickly and easily navigate to the relevant or important portions when they return to the paused livestream user interface.

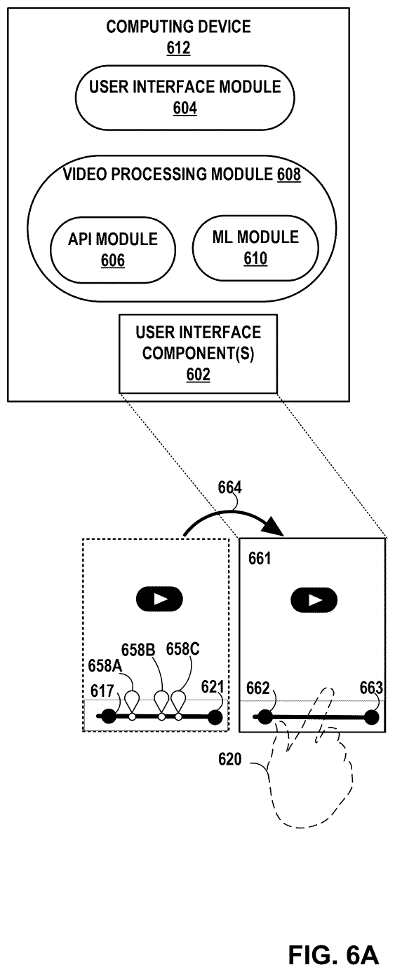

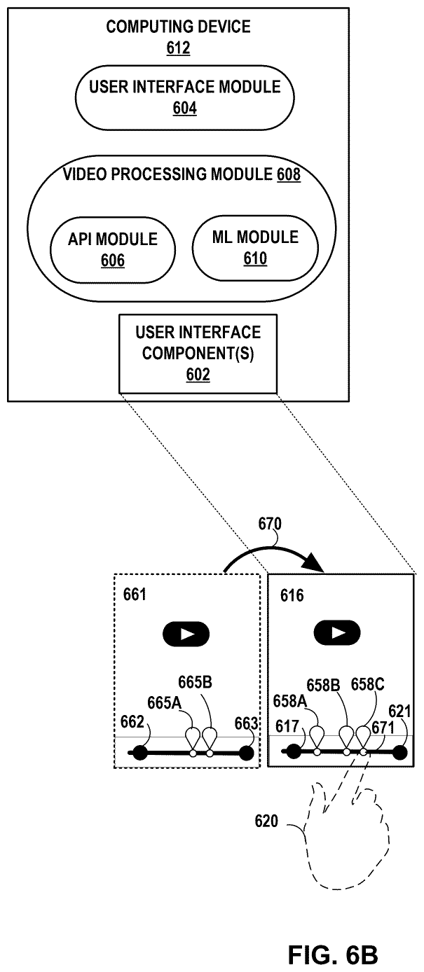

FIGS. 6A-6B are conceptual diagrams illustrating an example computing device for identifying important events in video content when switching between various applications, in accordance with one or more techniques of this disclosure. Computing device 612, user interface module 604, video processing module 608, API module 606, ML module 610, and user interface components 602 may be similar if not substantially similar to computing device 212, user interface module 204, video processing module 208, API module 206, ML module 210, and user interface components 202 of FIG. 2, respectively.

In some examples, the video livestream played on GUI 616 may be a first video livestream associated with a first application (e.g., GUI 616 may be a GUI of the first application for viewing the first video livestream), in which the first video livestream includes content for a first plurality of events occurring in real-time or near real-time. In some examples, the user input that pauses the first video livestream may be received in response to computing device 612 receiving an indication of the user switching from the first application to a second application (which may be illustrated as transition 664). That is, in the example of FIG. 6A, user 620 may interact with UI components 602 (e.g., a screen of computing device 612) to exit out of the first application and open up a second application. In some examples, the second application may be associated with a second video livestream that is transmitted to computing device 612 in real-time or near real-time. Responsive to receiving the indication of user 620 switching from the first application to the second application UI components 602 may output, for display, a second video livestream, in which the second video livestream may include content for a second plurality of events occurring in real-time or near real-time. As shown in the example of FIG. 6A, the second video livestream may be played on GUI 661 associated with the second application (e.g., GUI 661 may be a GUI of the second application for viewing the second video livestream).

As further shown in the example of FIG. 6A, while the first application is executing in the background, video processing module 608 may continuously receive the content for the first video livestream while the second video livestream is being played on GUI 661. That is, video processing module 608 may still receive content for the first video livestream as it is transmitted to computing device 612, and GUI 616 may be continuously updated to include an indication of each summary that is generated by machine learning module 610. For example, while user 620 may execute the second application to view the second video livestream, GUI 616 may be continuously updated in the background to include indications 658A, 658B, and 658C of summaries generated for important events identified by video processing module 608, in which each respective event begins between time 617 and time 621. As shown, indications 658A, 658B, and 658C of FIGS. 6A-6B, and indications 665A, 665B, and 665C of FIG. 6B, may be graphical components, such as text bubbles, that are interactive and can be selected by a user interacting with a portion of GUI 616 or GUI 661 that corresponds to a respective indication. Although not shown in FIGS. 6A-6B, indications 658A, 658B, 658C, 665A, 665B, and 665C may each include a text summary (similar to how indications 558A and 558B of FIG. 5 each include a text summary).

As further shown in the example of FIG. 6A, responsive to receiving a user input that pauses the second video livestream at time 662, video processing module 608 may receive the content for a second plurality of events that occur between time 662 and time 663 (e.g., the time at which the second video livestream is live). That is, in some examples, video processing module 608 may receive content from multiple different livestreams that are being played by multiple different applications executed by computing device 612.

In the example of FIG. 6B, video processing module 608 may identify at least a first event from the second plurality of events by at least applying machine learning module 610 to the content for the second plurality of events, in which the first event from the second plurality of events has at least the threshold level of importance. The first event from the second plurality of events may begin at a time between a time at which the second video livestream was paused (e.g., time 662) and a time at which the second video livestream is live (e.g., time 663). Video processing module 608 may generate a summary of the first event from the second plurality of events by at least applying machine learning module 610 to the content for the second plurality of events. As shown in FIG. 6B, UI components 602 may output, for display, indication 665A of the summary of the first event from the second plurality of events.

Responsive to receiving an indication of user 620 switching from the second application to the first application (illustrated by transition 670), UI components 602 may generate, for display, GUI 616 for adjusting the playback position of the first video livestream. That is, in general, user 620 may switch between various applications to view various livestreams, in which (with explicit user consent), video processing module 608 may continuously run in the background to continuously update the respective application GUI for each paused livestream. As shown in FIG. 6B, GUI 661 may be continuously updated in the background to include at least indication 665B of a summary generated for an important event identified by video processing module 608.

As such, each time user 620 returns to a paused livestream GUI, they may be presented with one or more indications of summaries for important events identified by video processing module 608 while the livestream was paused. User 620 may select an indication of a summary of an event to cause computing device 612 to adjust playback of the livestream to the time at which the event begins. As shown in FIG. 6B, user 620 may select indication 658C of a summary of a third event, in which computing device 612 may adjust playback of the livestream to the time 671 at which the third event begins.

As such, in general, the techniques described herein may be handled or facilitated directly by an operating system of computing device 612 rather than by a specific application or user-space program. For instance, the first application and the second application may be two different streaming platforms that do not use the same servers, protocols, formats, etc. As such, the techniques described herein may be performed by computing device 612, e.g., “on-device,” in which video processing module 608 may receive video content regardless of the application or platform at which the video content is being streamed (e.g., the techniques described herein may be platform-independent). In some examples, with proper permissions, video processing module 608 may access video content via GPU/video decoding pipelines, by using screen capture APIs provided by the operating system, a driver, kernel extension, low-level API, and the like. In some examples, with proper permissions (explicit user consent), video processing module 608 may be a background process or service running on computing device 612 that can monitor screen content and/or network traffic. In some examples, the video content received by video processing module 608 may be multimodal, and may be or include captured video frames, video streams, audio streams, and the like. As such, accuracy of event detection by machine learning module 610 may be improved. In general, machine learning module 610 may run computing device 612 (e.g., “on-device”) and/or on another device in communication with computing device 612 via a network (e.g., computing device 454 of FIG. 4). In this way, the techniques described herein may not require cloud processing, which may reduce computation costs.

In this way, the techniques described herein may provide solutions for dynamically updating video playback user interfaces to include generated summaries of important events identified in livestream media content. In this way, a user may pause a livestream being played by one application executing at their device, either to switch to another application (e.g., another application playing another livestream) or to attend to other tasks away from their device, and later may return to the paused livestream to be presented information that can help them more easily and quickly navigate to events they may wish to view. Thus, the techniques described herein may improve user experience when adjusting playback of livestream videos.

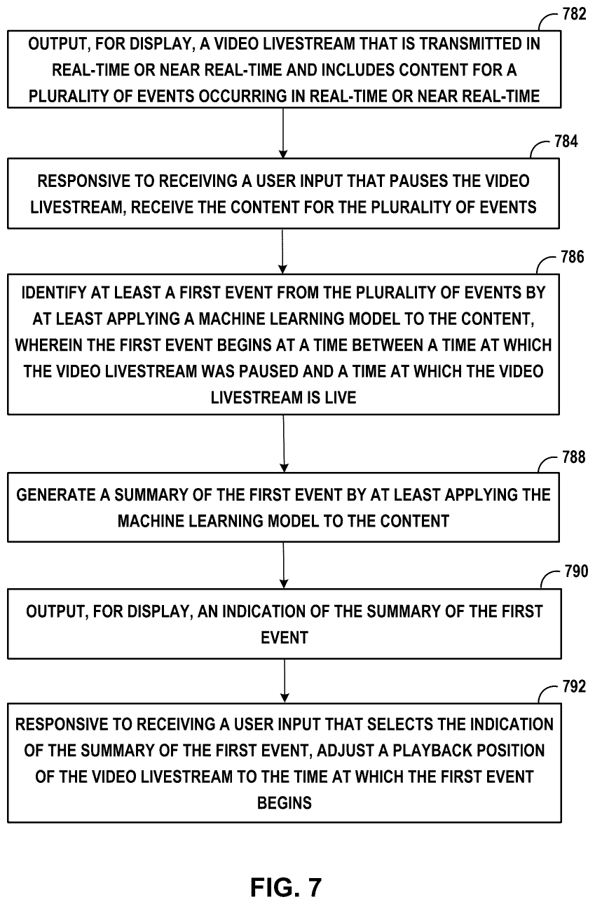

FIG. 7 is a flowchart illustrating an example operation of a computing device for adjusting a playback position of a video based on a selection of one or more identified events, in accordance with one or more techniques of this disclosure. For clarity, FIG. 7 may be described with respect to FIGS. 1-6B.

Computing device 112 outputs, for display by UI components 102, a video livestream that is transmitted to computing device 112 in real-time or near real-time, in which the video livestream includes content for a plurality of events occurring in real-time or near real-time (782). Responsive to receiving a user input that pauses the video livestream, video processing module 108 of computing device 112 receives the content for the plurality of events (784). Video processing module 108 identifies at least a first event from the plurality of events by at least applying machine learning module 110 to the content (786). In some examples, the first event from the plurality of events has at least a threshold level of importance. In some examples, the first event begins at time 557, which may be a time between time 117 at which the video livestream was paused and time 121 at which the video livestream is live. Video processing module 108 generates a summary of the first event by at least applying machine learning module 110 to the content (788). Computing device 112 outputs, for display by UI components 102, an indication 558A of the summary of the first event (790). Responsive to receiving a user input that selects indication 558A of the summary of the first event, computing device 112 adjusts a playback position of the video livestream to time 557 at which the first event begins (792).

This disclosure includes the following examples:

Example 1: A method includes outputting, by a computing device and for display, a video livestream that is transmitted to the computing device in real-time or near real-time, wherein the video livestream includes content for a plurality of events occurring in real-time or near real-time; responsive to receiving a user input that pauses the video livestream, receiving, by the computing device, the content for the plurality of events; identifying, by the computing device, at least a first event from the plurality of events by at least applying a machine learning model to the content, wherein the first event from the plurality of events has at least a threshold level of importance, and wherein the first event begins at a time between a time at which the video livestream was paused and a time at which the video livestream is live; generating, by the computing device, a summary of the first event by at least applying the machine learning model to the content; outputting, by the computing device and for display, an indication of the summary of the first event; and responsive to receiving a user input that selects the indication of the summary of the first event, adjusting, by the computing device, a playback position of the video livestream to the time at which the first event begins.

Example 2: The method of example 1, wherein the content for the plurality of events includes one or more of a transcript, video data, and audio data.

Example 3: The method of any of examples 1 and 2, wherein the time at which the first event begins is a first time, the method further includes identifying, by the computing device, at least a second event from the plurality of events by at least applying the machine learning model to the content, wherein the second event from the plurality of events has at least the threshold level of importance, and wherein the second event begins at a second time between the time at which the video livestream was paused and the time at which the video livestream is live; generating, by the computing device, a summary of the second event by at least applying the machine learning model to the content; outputting, by the computing device and for display, an indication of the summary of the second event; and responsive to receiving a user input that selects the indication of the summary of the second event, adjusting, by the computing device, a playback position of the video livestream to the second time at which the second event begins.

Example 4: The method of example 3, wherein the threshold level of importance is based on one or more user preferences, the method further includes generating, by the computing device, information indicative of each event from the plurality of events by at least applying the machine learning model to the content; and identifying, by the computing device, at least the first event and the second event by at least applying the machine learning model to the information indicative of each event and information indicative of the one or more user preferences.

Example 5: The method of any of examples 1 through 4, the method further includes responsive to receiving the user input that pauses the video livestream, generating, by the computing device, and for display, a user interface for adjusting the playback position of the video livestream, wherein the user interface includes a scrub bar, wherein the indication of the summary overlays the user interface, and wherein a positioning of the indication of the summary on the user interface corresponds to a portion of the scrub bar associated with the time at which the first event begins.

Example 6: The method of example 5, the method further includes receiving, by the computing device, a request to adjust the playback position of the video livestream to the time at which the video livestream is live, wherein the computing device continuously receives the content until the computing device receives the request to adjust the playback position of the video livestream to the time at which the video livestream is live, and wherein the user interface is continuously updated to include an indication of each summary that is generated until the computing device receives the request to adjust the playback position of the video livestream to the time at which the video livestream is live.

Example 7: The method of any of examples 1 through 6, wherein the video livestream is a first video livestream associated with a first application, and wherein the user input that pauses the first video livestream is received in response to receiving an indication of a user switching from the first application to a second application.

Example 8: The method of example 7, wherein the plurality of events is a first plurality of events, wherein the second application is associated with a second video livestream that is transmitted to the computing device in real-time or near real-time, the method further includes responsive to receiving the indication of the user switching from the first application to the second application, outputting, by the computing device and for display, the second video livestream, wherein the second video livestream includes content for a second plurality of events occurring in real-time or near real-time; responsive to receiving a user input that pauses the second video livestream, receiving, by the computing device, the content for the second plurality of events; identifying, by the computing device, at least a first event from the second plurality of events by at least applying the machine learning model to the content for the second plurality of events, wherein the first event from the second plurality of events has at least the threshold level of importance, and wherein the first event from the second plurality of events begins at a time between a time at which the second video livestream was paused and a time at which the second video livestream is live; generating, by the computing device, a summary of the first event from the second plurality of events by at least applying the machine learning model to the content for the second plurality of events; outputting, by the computing device and for display, an indication of the summary of the first event from the second plurality of events; and responsive to receiving an indication of the user switching from the second application to the first application, generating, by the computing device, and for display, the user interface for adjusting the playback position of the first video livestream.

Example 9: The method of any of examples 1 through 8, wherein the computing device is a first local computing device, and wherein applying the machine learning model further comprises: sending, by the first local computing device, and via a local network, the content to a second local computing device that includes the machine learning model; and receiving, by the first local computing device, and from the second local computing device via the local network, information indicative of the summary.

Example 10: A computing device includes one or more processors; and one or more storage devices that store instructions, wherein the instructions, when executed by the one or more processors, cause the one or more processors to: output, for display, a video livestream that is transmitted to the computing device in real-time or near real-time, wherein the video livestream includes content for a plurality of events occurring in real-time or near real-time; responsive to receiving a user input that pauses the video livestream, receive the content for the plurality of events; identify at least a first event from the plurality of events by at least applying a machine learning model to the content, wherein the first event from the plurality of events has at least a threshold level of importance, and wherein the first event begins at a time between a time at which the video livestream was paused and a time at which the video livestream is live; generate a summary of the first event by at least applying the machine learning model to the content; output, for display, an indication of the summary of the first event; and responsive to receiving a user input that selects the indication of the summary of the first event, adjust a playback position of the video livestream to the time at which the first event begins.

Example 11: The computing device of example 10, wherein the content for the plurality of events includes one or more of a transcript, video data, and audio data.

Example 12: The computing device of any of examples 10 and 11, wherein the time at which the first event begins is a first time, and wherein the instructions further cause the one or more processors to: identify at least a second event from the plurality of events by at least applying the machine learning model to the content, wherein the second event from the plurality of events has at least the threshold level of importance, and wherein the second event begins at a second time between the time at which the video livestream was paused and the time at which the video livestream is live; generate a summary of the second event by at least applying the machine learning model to the content; output, for display, an indication of the summary of the second event; and responsive to receiving a user input that selects the indication of the summary of the second event, adjust a playback position of the video livestream to the second time at which the second event begins.

Example 13: The computing device of example 12, wherein the threshold level of importance is based on one or more user preferences, and wherein the instructions further cause the one or more processors to: generate information indicative of each event from the plurality of events by at least applying the machine learning model to the content; and identify at least the first event and the second event by at least applying the machine learning model to the information indicative of each event and information indicative of the one or more user preferences.

Example 14: The computing device of any of examples 10 through 13, wherein the instructions further cause the one or more processors to: responsive to receiving the user input that pauses the video livestream, generate, for display, a user interface for adjusting the playback position of the video livestream, wherein the user interface includes a scrub bar, wherein the indication of the summary overlays the user interface, and wherein a positioning of the indication of the summary on the user interface corresponds to a portion of the scrub bar associated with the time at which the first event begins.

Example 15: The computing device of example 14, wherein the instructions further cause the one or more processors to: receive a request to adjust the playback position of the video livestream to the time at which the video livestream is live, wherein the one or more processors continuously receive the content until the one or more processors receive the request to adjust the playback position of the video livestream to the time at which the video livestream is live, and wherein the user interface is continuously updated to include an indication of each summary that is generated until the one or more processors receive the request to adjust the playback position of the video livestream to the time at which the video livestream is live.

Example 16: The computing device of any of examples 10 through 15, wherein the video livestream is a first video livestream associated with a first application, and wherein the user input that pauses the first video livestream is received in response to receiving an indication of a user switching from the first application to a second application.

Example 17: The computing device of example 16, wherein the plurality of events is a first plurality of events, wherein the second application is associated with a second video livestream that is transmitted to the computing device in real-time or near real-time, and wherein the instructions further cause the one or more processors to: responsive to receiving the indication of the user switching from the first application to the second application, output, for display, the second video livestream, wherein the second video livestream includes content for a second plurality of events occurring in real-time or near real-time; responsive to receiving a user input that pauses the second video livestream, receive the content for the second plurality of events; identify at least a first event from the second plurality of events by at least applying the machine learning model to the content for the second plurality of events, wherein the first event from the second plurality of events has at least the threshold level of importance, and wherein the first event from the second plurality of events begins at a time between a time at which the second video livestream was paused and a time at which the second video livestream is live; generate a summary of the first event from the second plurality of events by at least applying the machine learning model to the content for the second plurality of events; output, for display, an indication of the summary of the first event from the second plurality of events; and responsive to receiving an indication of the user switching from the second application to the first application, generate, for display, the user interface for adjusting the playback position of the first video livestream.

Example 18: The computing device of any of examples 10 through 17, wherein the computing device is a first local computing device, and wherein to apply the machine learning model, the instructions further cause the one or more processors to: send, via a local network, the content to a second local computing device that includes the machine learning model; and receive, from the second local computing device via the local network, information indicative of the summary.

Example 19: A non-transitory computer-readable storage medium encoded with instructions that, when executed by one or more processors, cause one or more processors to: output, for display, a video livestream that is transmitted in real-time or near real-time, wherein the video livestream includes content for a plurality of events occurring in real-time or near real-time; responsive to receiving a user input that pauses the video livestream, receive the content for the plurality of events; identify at least a first event from the plurality of events by at least applying a machine learning model to the content, wherein the first event from the plurality of events has at least a threshold level of importance, and wherein the first event begins at a time between a time at which the video livestream was paused and a time at which the video livestream is live; generate a summary of the first event by at least applying the machine learning model to the content; output, for display, an indication of the summary of the first event; and responsive to receiving a user input that selects the indication of the summary of the first event, adjust a playback position of the video livestream to the time at which the first event begins.

Example 20: The computer-readable storage medium of example 19, wherein the content for the plurality of events includes one or more of a transcript, video data, and audio data.

Example 21: The computer-readable storage medium of any of examples 19 and 20, wherein the time at which the first event begins is a first time, and wherein the instructions further cause the one or more processors to: identify at least a second event from the plurality of events by at least applying the machine learning model to the content, wherein the second event from the plurality of events has at least the threshold level of importance, and wherein the second event begins at a second time between the time at which the video livestream was paused and the time at which the video livestream is live; generate a summary of the second event by at least applying the machine learning model to the content; output, for display, an indication of the summary of the second event; and responsive to receiving a user input that selects the indication of the summary of the second event, adjust a playback position of the video livestream to the second time at which the second event begins.

Example 22: The computer-readable storage medium of example 21, wherein the threshold level of importance is based on one or more user preferences, and wherein the instructions further cause the one or more processors to: generate information indicative of each event from the plurality of events by at least applying the machine learning model to the content; and identify at least the first event and the second event by at least applying the machine learning model to the information indicative of each event and information indicative of the one or more user preferences.

Example 23: The computer-readable storage medium of any of examples 19 through 22, wherein the instructions further cause the one or more processors to: responsive to receiving the user input that pauses the video livestream, generate, for display, a user interface for adjusting the playback position of the video livestream, wherein the user interface includes a scrub bar, wherein the indication of the summary overlays the user interface, and wherein a positioning of the indication of the summary on the user interface corresponds to a portion of the scrub bar associated with the time at which the first event begins.

Example 24: The computer-readable storage medium of example 23, wherein the instructions further cause the one or more processors to: receive a request to adjust the playback position of the video livestream to the time at which the video livestream is live, wherein the one or more processors continuously receive the content until the one or more processors receive the request to adjust the playback position of the video livestream to the time at which the video livestream is live, and wherein the user interface is continuously updated to include an indication of each summary that is generated until the one or more processors receives the request to adjust the playback position of the video livestream to the time at which the video livestream is live.

Example 25: The computer-readable storage medium of any of examples 19 through 24, wherein the video livestream is a first video livestream associated with a first application, and wherein the user input that pauses the first video livestream is received in response to receiving an indication of a user switching from the first application to a second application.

Example 26: The computer-readable storage medium of example 25, wherein the plurality of events is a first plurality of events, wherein the second application is associated with a second video livestream that is transmitted in real-time or near real-time, and wherein the instructions further cause the one or more processors to: responsive to receiving the indication of the user switching from the first application to the second application, output, for display, the second video livestream, wherein the second video livestream includes content for a second plurality of events occurring in real-time or near real-time; responsive to receiving a user input that pauses the second video livestream, receive the content for the second plurality of events; identify at least a first event from the second plurality of events by at least applying the machine learning model to the content for the second plurality of events, wherein the first event from the second plurality of events has at least the threshold level of importance, and wherein the first event from the second plurality of events begins at a time between a time at which the second video livestream was paused and a time at which the second video livestream is live; generate a summary of the first event from the second plurality of events by at least applying the machine learning model to the content for the second plurality of events; output, for display, an indication of the summary of the first event from the second plurality of events; and responsive to receiving an indication of the user switching from the second application to the first application, generate, for display, the user interface for adjusting the playback position of the first video livestream.

Example 27: The computer-readable storage medium of any of examples 19 through 26, wherein the one or more processors are one or more processors of a first local computing device, and wherein the instructions further cause the one or more processors to: send, via a local network, the content to a second local computing device that includes the machine learning model; and receive, from the second local computing device via the local network, information indicative of the summary.

Example 28: A computer program product for identifying important events while a livestream is paused, the computer program product comprising instructions that, when executed by one or more processor, cause the one or more processors to: output, for display, a video livestream that is transmitted in real-time or near real-time, wherein the video livestream includes content for a plurality of events occurring in real-time or near real-time; responsive to receiving a user input that pauses the video livestream, receive the content for the plurality of events; identify at least a first event from the plurality of events by at least applying a machine learning model to the content, wherein the first event from the plurality of events has at least a threshold level of importance, and wherein the first event begins at a time between a time at which the video livestream was paused and a time at which the video livestream is live; generate a summary of the first event by at least applying the machine learning model to the content; output, for display, an indication of the summary of the first event; and responsive to receiving a user input that selects the indication of the summary of the first event, adjust a playback position of the video livestream to the time at which the first event begins.

Example 29: A computer program product comprising means for performing any of the methods of examples 1-10.

Example 30: A computing system comprising means for performing any of the methods of examples 1-10.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
outputting, by a computing device and for display, a graphical user interface including a video livestream that is transmitted to the computing device in real-time or near real-time, wherein the video livestream includes content for a plurality of events occurring in real-time or near real-time;
responsive to receiving a user input that pauses the video livestream within the graphical user interface, receiving, by the computing device, the content for the plurality of events;
while the video livestream is paused within the graphical user interface:
identifying, by the computing device, a subset of events from the plurality of events by at least applying a machine learning model to the content, wherein each event from the subset of events has at least a threshold level of importance, and wherein each event from the subset of events begins at a respective time between a time at which the video livestream was paused and a time at which the video livestream is live;
generating, by the computing device, a respective summary of each event from the subset of events by at least applying the machine learning model to the content; and
updating, by the computing device, the graphical user interface to present a respective indication of each respective summary, wherein the graphical user interface is continuously updated to present each respective indication of each respective summary that is generated until the computing device receives a request to adjust a playback position of the video livestream to the time at which the video livestream is live; and
responsive to receiving a user input that selects the respective indication of the respective summary of a respective event, adjusting, by the computing device, a playback position of the video livestream to the respective time at which the respective event begins.

2. The method of claim 1, wherein the content for the plurality of events includes one or more of a transcript, video data, and audio data.

3. (canceled)

4. The method of claim 1, wherein the threshold level of importance is based on one or more user preferences, wherein the subset of events includes at least a first event and a second event, the method further comprising:
generating, by the computing device, information indicative of each event from the plurality of events by at least applying the machine learning model to the content; and
identifying, by the computing device, at least the first event and the second event by at least applying the machine learning model to the information indicative of each event and information indicative of the one or more user preferences.

5. The method of claim 1, the method further comprising:
wherein the graphical user interface includes a scrub bar, and wherein a positioning of the respective indication of the respective summary within the graphical user interface corresponds to a portion of the scrub bar associated with the respective time at which the respective event begins.

6. The method of claim 1, the method further comprising:
receiving, by the computing device, the request to adjust the playback position of the video livestream to the time at which the video livestream is live, wherein the computing device continuously receives the content until the computing device receives the request to adjust the playback position of the video livestream to the time at which the video livestream is live.

7. The method of claim 1, wherein the video livestream is a first video livestream associated with a first application, and wherein the user input that pauses the first video livestream is received in response to receiving an indication of a user switching from the first application to a second application.

8. The method of claim 7, wherein the graphical user interface is a first graphical user interface, wherein the plurality of events is a first plurality of events, wherein the subset of events is a first subset of events, wherein the second application is associated with a second video livestream that is transmitted to the computing device in real-time or near real-time, the method further comprising:
responsive to receiving the indication of the user switching from the first application to the second application, outputting, by the computing device and for display, a second graphical user interface including the second video livestream, wherein the second video livestream includes content for a second plurality of events occurring in real-time or near real-time;
responsive to receiving a user input that pauses the second video livestream within the second graphical user interface, receiving, by the computing device, the content for the second plurality of events;
while the second video livestream is paused within the second graphical user interface:
identifying, by the computing device, a second subset of events from the second plurality of events by at least applying the machine learning model to the content for the second plurality of events, wherein each event from the second subset of events has at least the threshold level of importance, and wherein each event from the second subset of events begins at a respective time between a time at which the second video livestream was paused and a time at which the second video livestream is live;
generating, by the computing device, a respective summary of each event from the second subset of events by at least applying the machine learning model to the content for the second plurality of events; and
updating, by the computing device, the second graphical user interface to present a respective indication of each respective summary of each event from the second subset of events; and
responsive to receiving an indication of the user switching from the second application to the first application, outputting, by the computing device and for display, the first graphical user interface including the first video livestream.

9. The method of claim 1, wherein the computing device is a first local computing device, and wherein applying the machine learning model further comprises:
sending, by the first local computing device, and via a local network, the content to a second local computing device that includes the machine learning model; and
receiving, by the first local computing device, and from the second local computing device via the local network, information indicative of each respective summary.

10. A computing device comprising:
one or more processors; and
one or more storage devices that store instructions, wherein the instructions, when executed by the one or more processors, cause the one or more processors to:
output, for display, a graphical user interface including a video livestream that is transmitted to the computing device in real-time or near real-time, wherein the video livestream includes content for a plurality of events occurring in real-time or near real-time;
responsive to receiving a user input that pauses the video livestream within the graphical user interface, receive the content for the plurality of events;
while the video livestream is paused within the graphical user interface:
identify a subset of events from the plurality of events by at least applying a machine learning model to the content, wherein each event from the subset of events has at least a threshold level of importance, and wherein each event from the subset of events begins at a respective time between a time at which the video livestream was paused and a time at which the video livestream is live;
generate a respective summary of each event from the subset of events by at least applying the machine learning model to the content; and
update the graphical user interface to present a respective indication of each respective summary, wherein the graphical user interface is continuously updated to present each respective indication of each respective summary that is generated until the computing device receives a request to adjust a playback position of the video livestream to the time at which the video livestream is live; and
responsive to receiving a user input that selects the respective indication of the respective summary of a respective event, adjust a playback position of the video livestream to the respective time at which the respective event begins.

11. The computing device of claim 10, wherein the content for the plurality of events includes one or more of a transcript, video data, and audio data.

12. (canceled)

13. The computing device of claim 10, wherein the threshold level of importance is based on one or more user preferences, wherein the subset of events includes at least a first event and a second event, and wherein the instructions further cause the one or more processors to:
generate information indicative of each event from the plurality of events by at least applying the machine learning model to the content; and
identify at least the first event and the second event by at least applying the machine learning model to the information indicative of each event and information indicative of the one or more user preferences.

14. The computing device of claim 10,
wherein the graphical user interface includes a scrub bar, and wherein a positioning of the respective indication of the respective summary within the graphical user interface corresponds to a portion of the scrub bar associated with the respective time at which the respective event begins.

15. The computing device of claim 10, wherein the instructions further cause the one or more processors to:
receive the request to adjust the playback position of the video livestream to the time at which the video livestream is live, wherein the one or more processors continuously receive the content until the one or more processors receive the request to adjust the playback position of the video livestream to the time at which the video livestream is live.

16. The computing device of claim 10, wherein the video livestream is a first video livestream associated with a first application, and wherein the user input that pauses the first video livestream is received in response to receiving an indication of a user switching from the first application to a second application.

17. The computing device of claim 16, wherein the graphical user interface is a first graphical user interface, wherein the plurality of events is a first plurality of events, wherein the subset of events is a first subset of events, wherein the second application is associated with a second video livestream that is transmitted to the computing device in real-time or near real-time, and wherein the instructions further cause the one or more processors to:
responsive to receiving the indication of the user switching from the first application to the second application, output, for display, a second graphical user interface including the second video livestream, wherein the second video livestream includes content for a second plurality of events occurring in real-time or near real-time;
responsive to receiving a user input that pauses the second video livestream within the second graphical user interface, receive the content for the second plurality of events;
while the second video livestream is paused within the second graphical user interface:
identify a second subset of events from the second plurality of events by at least applying the machine learning model to the content for the second plurality of events, wherein each event from the second subset of events has at least the threshold level of importance, and wherein each event from the second subset of events begins at a respective time between a time at which the second video livestream was paused and a time at which the second video livestream is live;
generate a respective summary of each event from the second subset of events by at least applying the machine learning model to the content for the second plurality of events; and
update the second graphical user interface to present a respective indication of each respective summary of each event from the second subset of events; and
responsive to receiving an indication of the user switching from the second application to the first application, output, for display, the first graphical user interface including the first video livestream.

18. The computing device of claim 10, wherein the computing device is a first local computing device, and wherein to apply the machine learning model, the instructions further cause the one or more processors to:
send, via a local network, the content to a second local computing device that includes the machine learning model; and
receive, from the second local computing device via the local network, information indicative of each respective summary.

19. A non-transitory computer-readable storage medium encoded with instructions that, when executed by one or more processors, cause one or more processors to:
output, for display, a graphical user interface including a video livestream that is transmitted in real-time or near real-time, wherein the video livestream includes content for a plurality of events occurring in real-time or near real-time;
responsive to receiving a user input that pauses the video livestream within the graphical user interface, receive the content for the plurality of events;
while the video livestream is paused within the graphical user interface:
identify a subset of events from the plurality of events by at least applying a machine learning model to the content, wherein each event from the subset of events has at least a threshold level of importance, and wherein each event from the subset of events begins at a respective time between a time at which the video livestream was paused and a time at which the video livestream is live;
generate a respective summary of each event from the subset of events by at least applying the machine learning model to the content; and
update the graphical user interface to present a respective indication of each respective summary, wherein the graphical user interface is continuously updated to present each respective indication of each respective summary that is generated until the one or more processors receive a request to adjust a playback position of the video livestream to the time at which the video livestream is live; and
responsive to receiving a user input that selects the respective indication of the respective summary of a respective event, adjust a playback position of the video livestream to the respective time at which the respective event begins.

20. (canceled)

21. The method of claim 1, wherein adjusting the playback position of the video livestream further comprises:
responsive to receiving the user input that selects the respective indication of the respective summary of the respective event:
unpausing, by the computing device, the video livestream within the graphical user interface; and
adjusting, by the computing device, the playback position of the video livestream to the time at which the respective event begins.
